(19) United States
(12) Patent Application Publication
(10) Pub. No.: US 2023/0309016 A1
(43) Pub. Date: Sep. 28, 2023

(54) SIDELINK DISCONTINUOUS RECEPTION (DRX) MANAGEMENT

(71) Applicant: QUALCOMM Incorporated, San Diego, CA (US)

(72) Inventors: Qing LI, Princeton Junction, NJ (US); Hong CHENG, Basking Ridge, NJ (US); Ozcan OZTURK, San Diego, CA (US); Karthika PALADUGU, San Diego, CA (US); Peng CHENG, Beijing (CN); Dan VASSILOVSKI, Del Mar, CA (US); Gavin Bernard HORN, La Jolla, CA (US); Kapil GULATI, Belle Mead, NJ (US)

(21) Appl. No.: 18/041,673

(22) PCT Filed: Oct. 7, 2021
(86) PCT No.: PCT/CN2021/122526

§ 371 Date: Feb. 14, 2023

(30) Foreign Application Priority Data
Oct. 21, 2020 (WO) PCT/CN2020/122413

(51) Int. Cl. H04W 52/02; H04W 76/14; H04W 76/28

(52) U.S. Cl. CPC H04W 52/0216; H04W 76/14; H04W 76/28

(57) ABSTRACT

Certain aspects provide a method for wireless communication by a first user equipment (UE). The method may include: receiving information regarding at least one sidelink communication using sidelink discontinuous reception (DRX) for at least one application or service; determining at least one first sidelink DRX configuration based on the information; transmitting, to at least one second UE, an indication of the at least one first sidelink DRX configuration for the at least one sidelink communication; and receiving, from the at least one second UE, an indication of whether the at least one first sidelink DRX configuration is accepted for the at least one sidelink communication

### CROSS-REFERENCE TO RELATED APPLICATION

This application claims priority to PCT/CN2020/122413, filed Oct. 21, 2020, which is assigned to the assignee hereof and hereby expressly incorporated by reference herein in its entirety as if fully set forth below and for all applicable purposes.

### INTRODUCTION

Aspects of the present disclosure relate to wireless communications, and more particularly, to techniques for sidelink communication.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved sidelink communication.

Certain aspects provide a method for wireless communication by a first user equipment (UE). The method generally includes: receiving information regarding at least one sidelink communication using sidelink discontinuous reception (DRX) for at least one application or service; determining at least one first sidelink DRX configuration based on the information; transmitting, to at least one second UE, an indication of the at least one first sidelink DRX configuration for the at least one sidelink communication; and receiving, from the at least one second UE, an indication of whether the at least one first sidelink DRX configuration is accepted for the at least one sidelink communication.

Certain aspects provide a method for wireless communication by a first UE. The method generally includes receiving, from a second UE, an indication of at least one first sidelink DRX configuration for at least one application or service to be used for at least one sidelink communication using sidelink DRX; determining whether the at least one first sidelink DRX configuration is acceptable for the at least one sidelink communication using the sidelink DRX; and transmitting, to the second UE, an indication of whether the at least one first sidelink DRX configuration is accepted for the at least one sidelink communication based on the determination.

Certain aspects provide a method for wireless communication by a base station. The method generally includes receiving, from a UE, information regarding at least one sidelink communication using sidelink DRX for at least one application or service; determining at least one first sidelink DRX configuration to be used for the at least one sidelink communication based on the information; transmitting, to the UE, an indication of the at least one first DRX configuration; and receiving, from the UE, an indication of whether the at least one first DRX configuration is accepted for the at least one sidelink communication.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIGS. 3A and 3B show diagrammatic representations of example vehicle to everything (V2X) systems in accordance with some aspects of the present disclosure.

FIG. 4 illustrates an example sidelink discontinuous reception (SL DRX) configuration of a UE, in some aspects.

FIG. 5 is a flow diagram illustrating example operations for wireless communication, in accordance with certain aspects of the present disclosure.

FIG. 6 is a flow diagram illustrating example operations for wireless communication, in accordance with certain aspects of the present disclosure.

FIG. 7 is a flow diagram illustrating example operations for wireless communication, in accordance with certain aspects of the present disclosure.

FIG. 8A illustrates a protocol for configuring a SL DRX for unicast communication, in accordance with certain aspects of the present disclosure.

FIG. 8B illustrates a protocol for configuring a SL DRX for groupcast communication, in accordance with certain aspects of the present disclosure.

FIG. 8C illustrates a protocol for configuring a SL DRX for broadcast or connectionless groupcast communication, in accordance with certain aspects of the present disclosure.

FIG. 9A illustrates a network controlled protocol for configuring a SL DRX for unicast communication, in accordance with certain aspects of the present disclosure.

FIG. 9B illustrates a network controlled protocol for configuring a SL DRX for groupcast communication, in accordance with certain aspects of the present disclosure.

FIG. 9C illustrates a network controlled protocol for configuring a SL DRX for broadcast or connectionless groupcast communication, in accordance with certain aspects of the present disclosure.

FIGS. 10 and 11 illustrate communications devices that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sidelink (SL) discontinuous reception (SL DRX). For example, certain aspects provide techniques for configuration or reconfiguration of an SL DRX. For example, a UE may start an application which may provide SL DRX information for one or more SL DRX configuration. Based on the SL DRX information (e.g., SL DRX configuration(s)), the UE may determine that a particular SL DRX configuration is to be configured with another UE for unicast, a group of UEs for groupcast, or UEs associated with a service for broadcast. In some cases, the SL DRX configuration may be configured using an established sidelink (i.e. PC5) radio resource control (RRC) link (connection), or activated or deactivated using sidelink control information (SCI) or sidelink medium access control (MAC) control element (CE). Management of SL DRX configurations may be performed in an attempt to coordinate SL DRX patterns for UEs of the UE pair, the group of UEs, or the UEs associated with a service. Coordination of the SL DRX patterns reduces the number of sleep and wake up cycles of UEs, improving the UE power efficiency as well as meeting performance specifications. In some aspects, the configuration or reconfiguration of SL DRX may be UE managed via a PC5 interface (e.g., a Tx or Rx UE, RSU, group lead or cluster lead, a scheduling UE), and in other aspects, may be managed by the network (e.g., a base station or gNB), as described in more detail herein.

The following description provides examples of configurations for sidelink (SL) communication in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

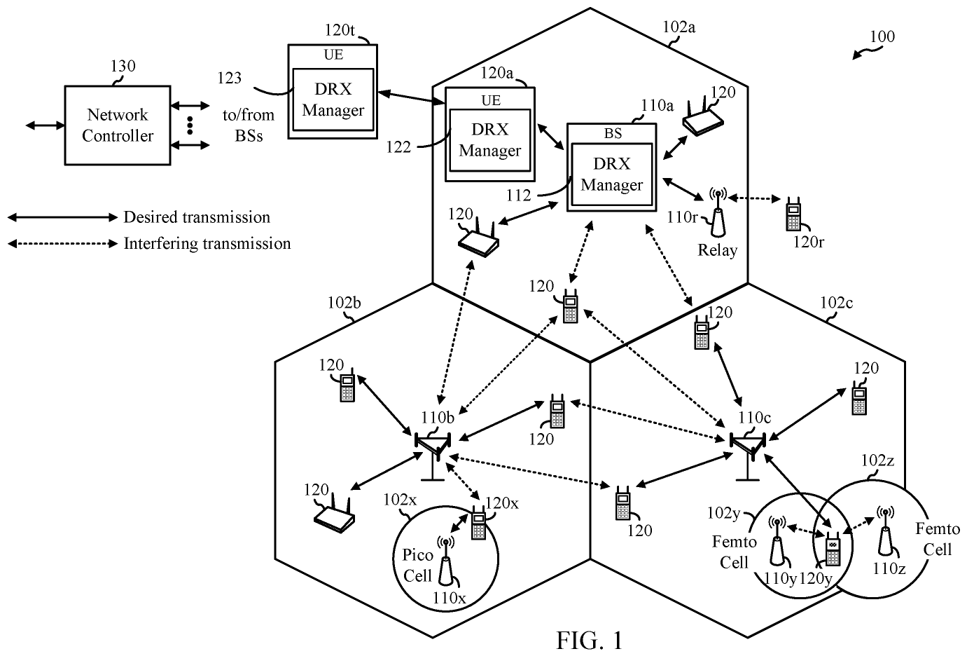

FIG. 1 illustrates an example wireless communication network 100 in which aspects of the present disclosure may be performed. For example, the wireless communication network 100 may be an NR system (e.g., a 5G NR network).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured for managing sidelink in a discontinuous reception (DRX) mode of operations. As shown in FIG. 1, the UE 120a includes a DRX manager 122. In this case, the DRX manager 122 may be configured for: determining information regarding communicating using sidelink discontinuous reception (DRX) or sidelink DRX configuration(s); determining at least one first DRX configuration based on the information or one or more sidelink DRX configurations; transmitting, to at least one second UE, an indication of the at least one first DRX configuration; and receiving, from the at least one second UE, an indication of whether the first DRX configuration is accepted for the communication.

The UE 120t includes a DRX manager 123 configured for: determining information regarding communicating using sidelink discontinuous reception (DRX) or at least one sidelink DRX configuration; receiving, from a second UE, an indication of at least one first discontinuous reception (DRX) configuration to be used for communication using sidelink DRX; determining whether the at least one first DRX configuration is acceptable for the communication using sidelink DRX; and transmitting, to the second UE, an indication of whether the first DRX configuration is accepted for the communication based on the determination. The BS 110 may include a DRX manager 112 configured for: receiving, from a user equipment (UE), information regarding communicating using sidelink discontinuous reception (DRX) or one or more sidelink DRX configurations; determining at least one first DRX configuration to be used for the sidelink communication based on the information or one or more sidelink DRX configurations; transmitting, to the UE, an indication of the at least one first DRX configuration; and receiving, from the UE, an indication of whether the at least one first DRX configuration is accepted for the sidelink communication.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

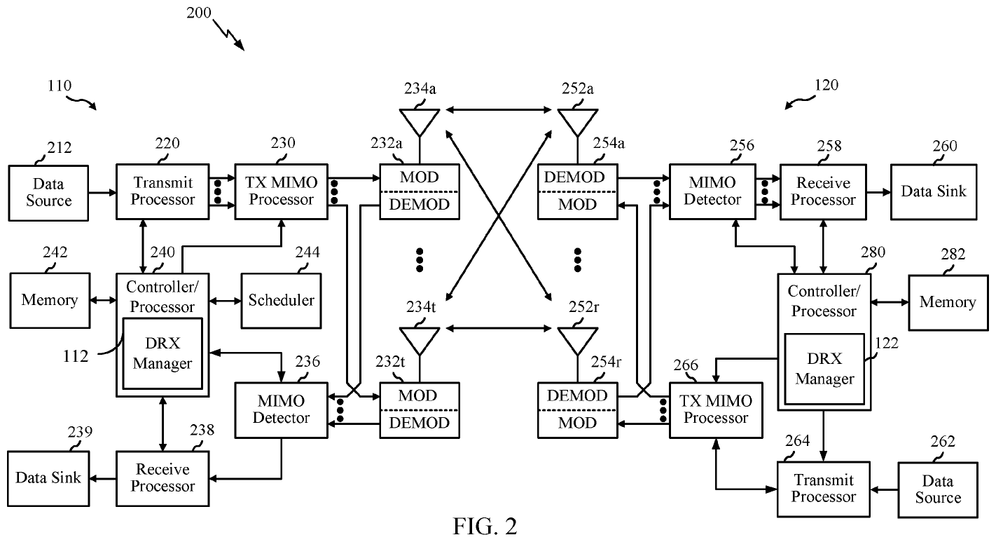

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information-reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, cyclic prefix-OFDM (CP-OFDM), etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. As shown in FIG. 2, the controller/processor 280 of the UE 120a has the DRX manager 122. The controller/processor 240 of the BS 110 may include the DRX manager 112. Although shown at the Controller/Processor, other components of the UE 120a and BS 110 may be used performing the operations described herein.

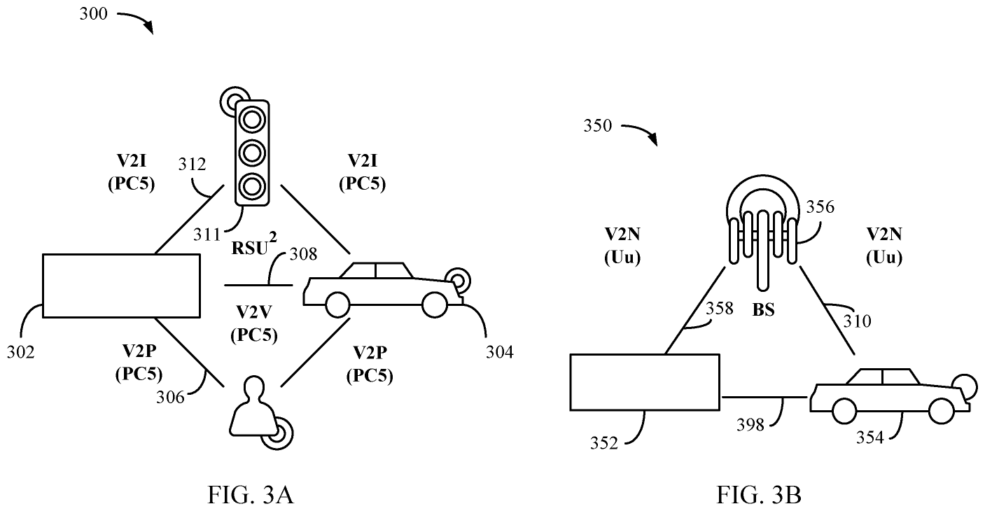

FIGS. 3A and 3B show diagrammatic representations of example vehicle to everything (V2X) systems in accordance with some aspects of the present disclosure. For example, the UEs shown in FIGS. 3A and 3B may communicate via sidelink channels and may perform sidelink CSI reporting as described herein.

The V2X systems, provided in FIGS. 3A and 3B provide two complementary transmission modes. A first transmission mode, shown by way of example in FIG. 3A, involves direct communications (for example, also referred to as side link communications) between participants in proximity to one another in a local area. A second transmission mode, shown by way of example in FIG. 3B, involves network communications through a network, which may be implemented over a Uu interface (for example, a wireless communication interface between a radio access network (RAN) and a UE). As illustrated, UEs 352, 354 may communicate with each other using a sidelink (SL) 398.

Referring to FIG. 3A, a V2X system 300 (for example, including vehicle to vehicle (V2V) communications) is illustrated with two UEs 302, 304 (e.g., vehicles). The first transmission mode allows for direct communication between different participants in a given geographic location. As illustrated, a vehicle can have a wireless communication link 306 with an individual (V2P) (for example, via a UE) through a PC5 interface. Communications between the UEs 302 and 304 may also occur through a PC5 interface 308. In a like manner, communication may occur from a UE 302 to other highway components (for example, roadside unit (RSU) 311), such as a traffic signal or sign (V2I) through a PC5 interface 312. With respect to each communication link illustrated in FIG. 3A, two-way communication may take place between elements, therefore each element may be a transmitter and a receiver of information. The V2X system 300 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 3B shows a V2X system 350 for communication between a UE 352 (e.g., vehicle) and a UE 354 (e.g., vehicle) through a network entity 356. These network communications may occur through discrete nodes, such as a base station (for example, an eNB or gNB), that sends and receives information to and from (for example, relays information between) UEs 352, 354. The network communications through vehicle to network (V2N) links (e.g., Uu links 358 and 310) may be used, for example, for long range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. Other applications of sidelink communications may include public safety or service announcement communications, communications for proximity services, communications for UE-to-network relaying, device-to-device (D2D) communications, Internet of Everything (IoE) communications, Internet of Things (IoT) communications, important mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink control channel (PSCCH), a physical sidelink shared channel (PSSCH), and a physical sidelink feedback channel (PSFCH). The PSSCH may also carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as acknowledgement (ACK) or negative acknowledgement (NACK) for hybrid automatic repeat request HARQ feedback. The PSSCH may also carry MAC CE for channel state information (CSI) related to a sidelink channel quality.

### Discontinuous Reception (DRX) on Sidelink

In a discontinuous reception (DRX) mode of operation, a UE may enter a low power (“sleep”) mode (also referred to herein as a “sleep phase”), which may also be referred to as a low power state, for a certain period of time (referred to as a DRX OFF phase, or duration) and wakes up again during a DRX on (e.g., awake phase) duration (also referred to as a DRX on phase) to check if there is any data to be received. The cycle of sleep and wake up (DRX on and DRX off) durations repeats over time, allowing the UE to save power while maintaining communication.

Currently, DRX is not defined for sidelink operations, and thus, a receiver (Rx) UE has to monitor for sidelink control information (SCI) for each time slot, causing high power consumption which is especially detrimental for battery power confined UEs such as pedestrian UEs for Vehicle-to-Person (V2P) service on sidelink or UEs for public safety services on sidelink. Thus, SL DRX design is used to save power for sidelink communications. As compared with communications between a UE and a base station (BS) on the Uu interface, sidelink communications among different UEs are more diverse. For example, a UE may simultaneously engage in different vehicle-to-everything (V2X) services with different quality of service (QoS) specifications (e.g., reliability, latency, etc.), and different communication types (e.g., broadcast, groupcast and unicast). Therefore, a one-size-fits-all SL DRX design may not be best for both saving power and meeting diverse QoS specifications.

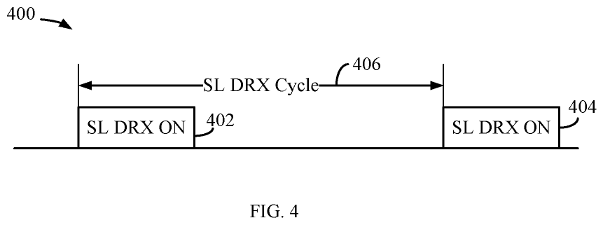

FIG. 4 illustrates an example SL DRX configuration 400 of a UE. As illustrated, the SL DRX configuration 400 may include SL DRX on phases 402, 404. As described herein, an SL DRX on phase repeats every SL DRX cycle 406. For example, the DRX on phase 402 is during a DRX cycle 406, as illustrated. A receiver (Rx) UE of unicast or Rx UEs of broadcast or groupcast are awake during the DRX on phases 402, 404 to communicate with one or more Tx UEs for unicast, broadcast or groupcast, (e.g., Rx UE(s) monitors for signaling that may be received from the Tx UE(s)), and Rx UE(s) are in a low power state (e.g., sleep phase) at other times (also referred to as SL DRX sleep phase) during which Tx UE(s) may communicate to other Rx UE(s) of another service, group or UE pair or Tx UE(s) may also in a low power state. In addition, a UE of a service, a group, or a UE pair, becomes a Tx UE on sidelink when it has a packet to transmit on sidelink to the other UEs of a service or a group or to the other UE of a UE pair. Hence, differently from the DRX for a UE monitoring downlink control information (DCI) from a base station at Uu interface, SL DRX is bidirectional on sidelink for both Tx UE and Rx UE(s) for a service, a group or a UE pair and therefore an SL DRX forms sidelink traffic patterns for a service, a group or a UE pair.

### Example SL DRX Operations

As described herein, a sidelink discontinuous reception (SL DRX) may be formed to assist an Rx UE for unicast, broadcast or groupcast in determining when to monitor for sidelink control information(s) (SCI(s)) from Tx UE(s), the SCI scheduling a sidelink transmission to the Rx UE(s). Thus, SL DRX allows the Rx UE(s) to save power by non-contiguously monitoring SCI. As described herein, an SL DRX is bidirectional and also forms the traffic pattern for a Tx UE. In other words, a Tx UE may not transmit while Rx UE(s) is not in an SL DRX on state for monitoring SCI(s). In other words, if the Rx UE(s) is not in a DRX on phase, the Rx UE may be in a sleep mode of operation and may not monitor for SCIs. Thus, a Tx UE may also forgo transmissions to other UEs that are not in a DRX on phase.

If different sidelink DRXs are formed for different communications so as to group Rx UEs accordingly, such as a communication among all UEs with an application or service using broadcast, a communication among UEs within a group using groupcast, or a communication between a UE pair using unicast, a UE participating in different sidelink communications may have multiple sidelink DRX configurations for different applications or services, different groups, or different UE pairs. Therefore sidelink DRX management is important to support efficient sidelink DRX operations, especially for out of network's coverage scenario.

Certain aspects of the present disclosure provide an efficient management of sidelink DRXs (SL DRXs) to facilitate both power saving and performance improvement. The aspect described herein describe protocols for SL DRX in various modes of operation. For example, for resource allocation mode 1, a Tx UE may be under the control of a BS (e.g., gNB), but the Rx UE may not be under the control of the BS (e.g., under another BS's coverage or out of a BS's coverage). Thus, certain aspects provide techniques for configuration or reconfiguration of an Rx UE with SL DRX(s), if the Rx UE is out of the BS's coverage. Moreover, certain aspects provide techniques for activating or deactivating, or switching an SL DRX, if the Rx UE is out of the BS's coverage.

For resource allocation mode 2, both the Rx and Tx UEs may be either in network's coverage or out of network's coverage. Certain aspects provide techniques for improving the SL DRX configurations and reconfigurations, if both UEs are out of network's coverage, and activating or deactivating, or switching an SL DRX, if the UEs are out of network's coverage.

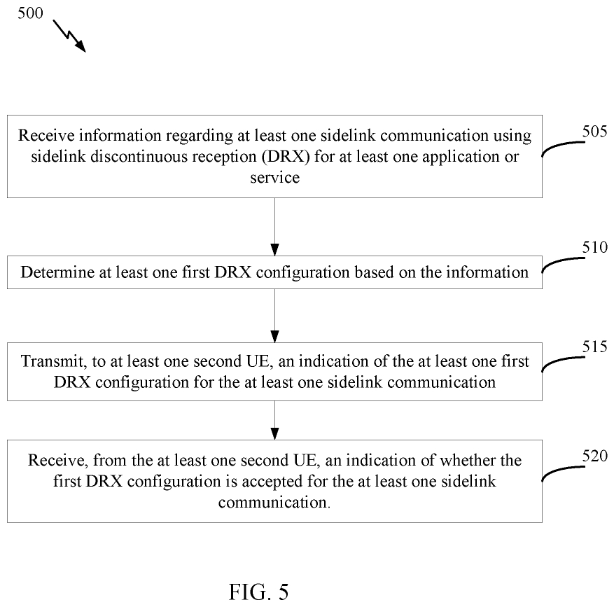

FIG. 5 is a flow diagram illustrating example operations 500 for wireless communication, in accordance with certain aspects of the present disclosure. The operations 500 may be performed, for example, by a first UE (e.g., such as a UE 120a in the wireless communication network 100, or a UE 120t out of the wireless communication network 100), such as a UE initiating or transmitting a new configuration or reconfiguration of SL DRX.

Operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 may begin, at block 505, with the first UE receiving (e.g., from a base station or a higher layer of the first UE or a second UE) information regarding at least one sidelink communication using sidelink DRX for at least one application or service. At block 510, the first UE determines at least one first DRX configuration based on the information.

In some implementations, the first UE may transmit, to a base station, an indication of the information regarding communicating using the sidelink DRX or at least one preferred sidelink DRX configuration, and receive, from the base station, an indication of the at least one first DRX configuration to be used based on the information or at least one preferred sidelink DRX configuration, the determination at block 510 of the at least one first DRX configuration being based on the indication of the at least one first DRX configuration from the base station. At block 515, the first UE transmits, to at least one second UE, an indication of the at least one first DRX configuration for the at least one sidelink communication, and at block 520, receives, from the at least one second UE, an indication of whether the first DRX configuration is accepted for the at least one sidelink communication.

In some aspects, the first UE may receive, from the base station, an indication of a second DRX configuration to be used (e.g., reconfiguration from the base station), transmit, to the at least one second UE, an indication of the second DRX configuration, and receive, from the at least one second UE, an indication of whether the second DRX configuration is accepted for the communication.

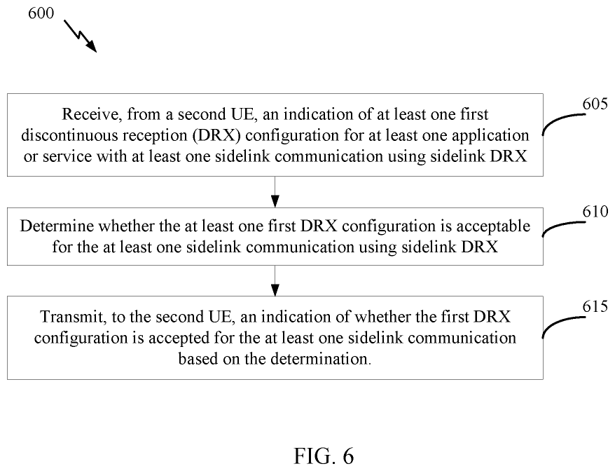

FIG. 6 is a flow diagram illustrating example operations 600 for wireless communication, in accordance with certain aspects of the present disclosure. The operations 600 may be understood to be complementary to the operations 500 of FIG. 5. The operations 600 may be performed, for example, by a first UE (e.g., such as a UE 120a in the wireless communication network 100, or a UE 120t out of the wireless communication network 100), such as a UE receiving a new configuration or reconfiguration of SL DRX.

Operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 600 may begin, at block 605, with the first UE receiving, from a second UE, an indication of at least one first DRX configuration for at least one application or service with at least one sidelink communication using sidelink DRX. At block 610, the first UE determines whether the at least one first DRX configuration is acceptable for the at least one sidelink communication using sidelink DRX, and at block 615, transmits, to the second UE, an indication of whether the first DRX configuration is accepted for the at least one sidelink communication based on the determination.

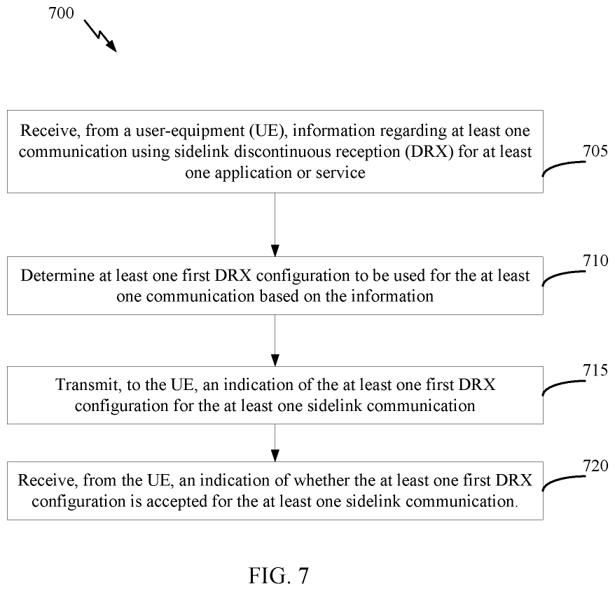

FIG. 7 is a flow diagram illustrating example operations 700 for wireless communication, in accordance with certain aspects of the present disclosure. The operations 700 may be performed, for example, by a BS (e.g., such as the BS 110a in the wireless communication network 100).

The operations 700 may be implemented as software components that are executed and run on one or more processors (e.g., controller/processor 240 of FIG. 2).

Further, the transmission and reception of signals by the BS in operations 700 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 700 may include, at block 705, the BS receiving, from a user equipment (UE), information regarding communicating using sidelink discontinuous reception (DRX) or one or more preferred sidelink DRX configurations for at least one application or service with at least one sidelink communication. At block 710, the BS may determine at least one first DRX configuration to be used for the at least one sidelink communication based on the information or sidelink DRX configuration(s), at block 715, transmit, to the UE, an indication of the at least one first DRX configuration for the at least one communication, and at block 720, receive, from the UE, an indication of whether the at least one first DRX configuration is accepted for the at least one sidelink communication.

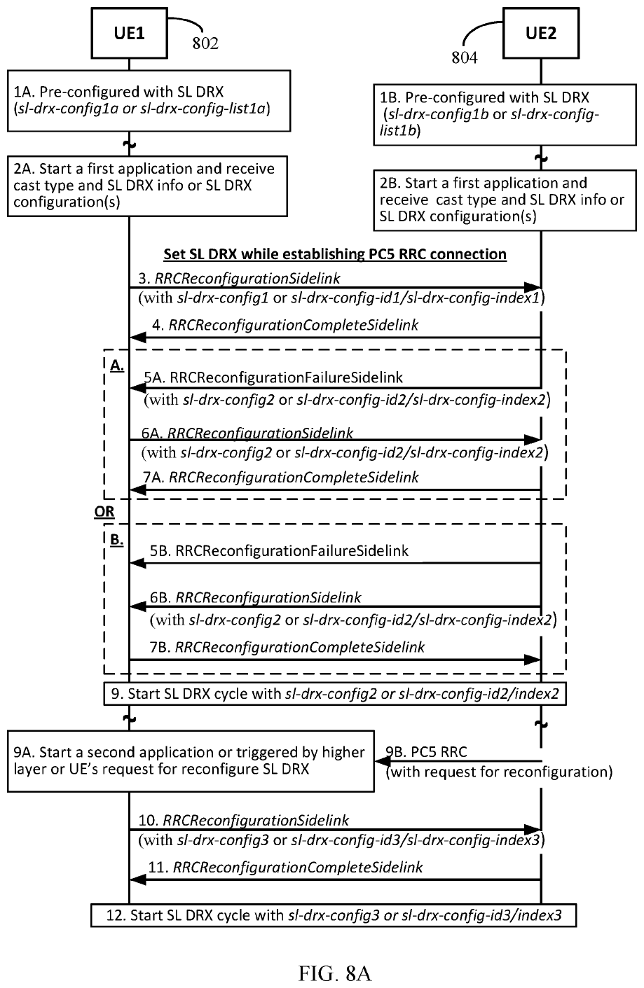

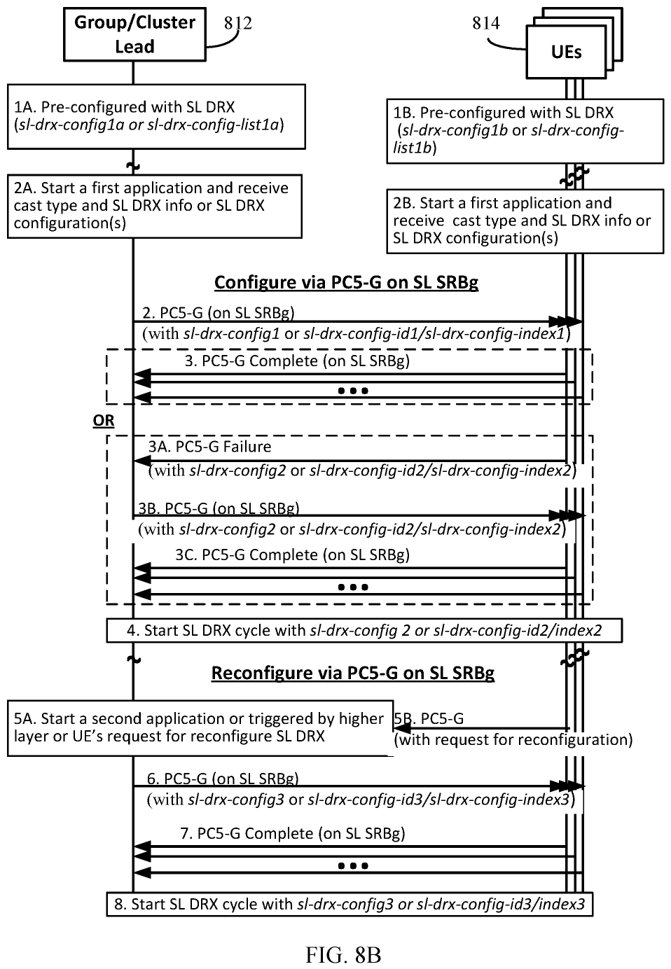

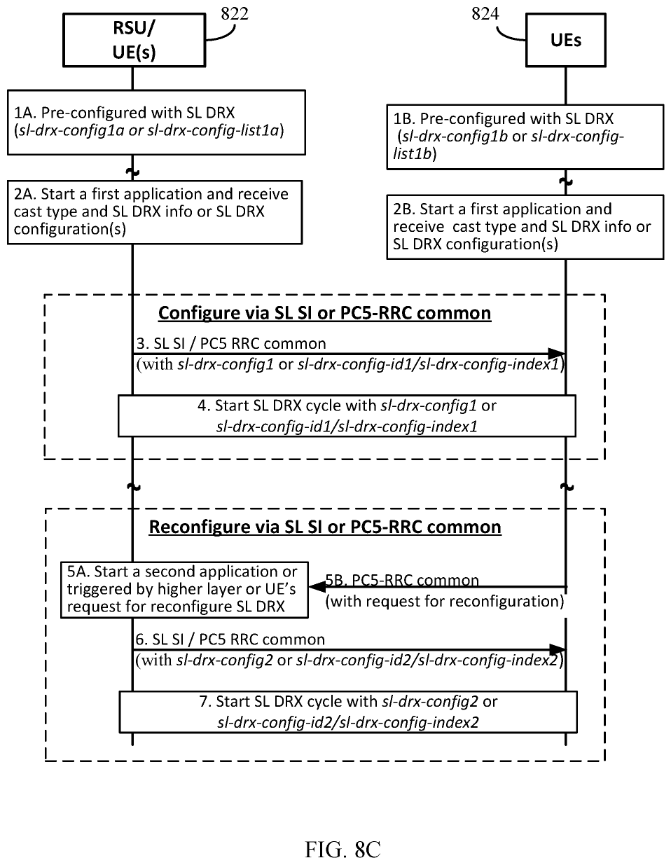

Certain aspects provide apparatus and techniques for SL DRX management for resource allocation mode 2, as described herein. A pre-configured SL DRX configuration(s) may be reconfigured or coordinated between a UE pair with a PC5 connection via a radio resource control (RRC) reconfiguration sidelink (RRCReconfigurationSidelink) message for sidelink unicast; reconfigured or coordinated by a group lead or cluster lead via PC5-groupcast (G) (e.g., a group common PC5 RRC) on an SL signaling radio bearer of a group (SRBg) for sidelink connection based groupcast; or reconfigured or coordinated by a roadside unit (RSU), a group lead or cluster lead, a scheduling UE or a Tx UE via SL system information (SI) or sidelink common PC5 RRC on a common SL signaling radio bearer (SRB) (e.g., SRBO like) for broadcast or connectionless groupcast, as described in more detail herein with respect to FIGS. 8A, 8B, 8C.

In some aspects, an SL DRX configuration may be activated or deactivated (e.g., on or off), and selected (e.g., activated) from SL DRX configurations or switched to a different SL DRX configuration based on a trigger or satisfying a certain condition or criteria such as for an application or service, for a sidelink communication, for a data traffic change, for an event or road situation, for a location, for a communication range, for a latency or reliability or power saving goals, for a battery power level, for a sidelink loading or congestion level, etc. The SL DRX configuration may be activated, deactivated, selected or switched using sidelink MAC CE or sidelink control information (SCI), a wake up indication from a Tx UE, a scheduling UE, an RSU, a group lead or cluster lead (e.g., distance based, region or zoning based), or implicitly using resource pool selection.

A UE participating in different sidelink communications may have different sidelink DRX configurations preconfigured via manufacture, V2X server, or a BS while in network's coverage. Coordination of sidelink DRX configurations among UEs in proximity or within a group or between a UE pair is important if the preconfigured SL DRXs do not align properly, facilitating power savings and performance specifications such as latency and reliability.

FIG. 8A illustrates a protocol for configuring or reconfiguring a SL DRX for one or more unicast communications (e.g., coordinating or negotiating SL DRX configuration(s) between a UE pair with PC5 RRC links), in accordance with certain aspects of the present disclosure. As illustrated, at blocks 1A and 1B, UE 802 and UE 804 may be preconfigured with SL DRX information (e.g., referred to herein as sl-drx-info) or one (e.g., sl-drx-config1a and sl-drx-config1b respectively) or more candidate SL DRX configurations (e.g., sl-drx-config-list1a and sl-drx-config-list1b respectively), for example, one or more candidate SL DRX configurations based on QoS specifications (e.g., associated or mapped with QoS profile(s) or QoS parameters, for example via a look-up table (LUT), for different QoS flows associated to one or more services or service types). At blocks 2A and 2B, UE 802 and UE 804 may start a first application (e.g., a service or service type with one or more QoS flows). Thus, UE 802 and UE 804 may receive an indication of at least one cast type (e.g., unicast as exemplified herein) and the associated PC5 link information (e.g., a PC5 link ID or pair of layer 2 source ID and destination ID or a layer 2 destination ID), associated SL DRX information, or candidate SL DRX configuration(s) (e.g., associated or mapped with the QoS profile or QoS parameters for the service or service type or the PC5 link ID or pair of layer 2 source ID and destination ID or a layer 2 destination ID) from a higher layer of each respective UE). A higher layer, herein till further description, may be application layer, or V2X service layer.

SL DRX information (e.g., referred to herein as sl-drx-info) may include period(s) and duty cycle(s) for periodic traffics or traffic pattern(s) for aperiodic traffics, data packet size(s), quality of service (QoS) profile or QoS parameters such as latency and reliability specification(s) and data rate or volume and communication priority or priorities, power saving specification(s) such as for battery constrained UEs, communication range(s), location or zoning, SL DRX triggering criteria or condition(s) for SL DRX activation, deactivation, selecting or switching, etc.

An SL DRX configuration (e.g., referred to herein as sl-drx-config) may include at least SL DRX cycle length (i.e. SL DRX pattern), SL DRX On duration (i.e. the duration of UEs' active state or phase), SL DRX offset (i.e. SL DRX On starting point), SL DRX Inactivity timer value(s), SL DRX HARQ RTT timer value(s), SL DRX HARQ Retransmission timer value(s), etc. For example, an SL DRX cycle length may be associated or mapped with a QoS profile or QoS parameter (e.g., a value or a range of latency or packet delay budget (PDB) or a traffic pattern), an SL DRX Inactivity timer value may be associated or mapped with a QoS profile or QoS parameter (e.g., a value or a range of latency or packet delay budget (PDB), reliability or priority, data rate or volume, etc.), an SL DRX HARQ RTT timer value associated to UE's capability (e.g., processing time line), an SL DRX HARQ Retransmission timer value associated or mapped with a QoS profile or QoS parameter (e.g., a value or a range of latency or packet delay budget (PDB), reliability or priority, data rate or volume, etc.), and an SL DRX Offset associated or mapped to or derived from a PC5 RRC link ID for a unicast, or a pair of source ID and destination ID or a destination ID for one direction of a unicast (e.g., the communication direction from UE 802 to UE 804). In some aspects, the SL DRX Offset may be derived with such examples, Offset=Offset₀×(destination-ID mod M) or Offset=Offset₀×[(link-ID mod M)+Offset_{direction}], where Offset₀ is the time offset (e.g., in slots, subframes, or time unit) between possible SL DRX allocations or between possible adjacent SL DRX On durations configured or mapped for one or more sidelink communications based on QoS or other sidelink configuration parameters such as On duration, Inactivity timer, HARQ retransmission timer, etc., M is the number of possible SL DRX On starting points or SL DRX On allocations within a time window, e.g., a SL DRX cycle length, Offset_{direction} is a value in [0, M−I] inclusively for a direction of the unicast between two paired UEs (e.g., one value, for example “0”, for the unicast direction from UE1 to UE2, another value, for example “1” or “M−1”, for the unicast direction from UE2 to UE1). In some aspects, the SL DRX Offset may be determined based on the other SL DRX configurations for different unicasts for a UE. In some aspects, the SL DRX Offset may be determined based on the SL DRX Offset from SL DRX information received from Rx UE 804 or preferred SL DRX configuration(s).

The UE 802 may determine an SL DRX configuration based on SL DRX information or candidate SL DRX configuration(s) received from a higher layer or the paired UE (e.g., UE 804 as exemplified at operation 9B with SL DRX information or preferred SL DRX configuration) and then transmit the SL DRX configuration for the unicast communication from UE 802 to UE 804 during or after establishing a PC5 RRC connection with UE 804. For example, at operation 3, UE 802 may determine a SL DRX configuration (e.g., sl-drx-config1), for example, based on the SL DRX information or one or more candidate SL DRX configurations received from the higher layer or the paired UE 804, and transmit the determined SL DRX configuration via an RRC configuration message for sidelink (e.g., RRCReconfigurationSidelink). As illustrated, the RRC reconfiguration sidelink message may either indicate an SL DRX configuration (e.g., sl-drx-config1 containing at least an SL DRX cycle length, an SL DRX Offset value, an SL DRX On timer value, an SL DRX Inactivity timer value, or SL DRX HARQ RTT timer value and SL DRX HARQ Retransmission timer value if HARQ is enabled), or identify an SL DRX configuration from a list of configurations (e.g., sl-drx-config-list1) by indicating an SL DRX configuration identifier (e.g., sl-drx-config-id1) or index (e.g., sl-drx-config-index1) from the list or code point of a LUT with candidate SL DRXs associated or mapped with QoS profile or QoS parameters. At operation 4, UE 804 confirms the configuration or reconfiguration via an RRC reconfiguration complete sidelink message (e.g., RRCReconfigurationCompleteSidelink). In some cases, the RRC reconfiguration complete sidelink message (e.g., RRCReconfigurationCompleteSidelink) may be used for acknowledging implicitly that the SL DRX configuration included in the received RRC reconfiguration sidelink message (e.g., RRCReconfigurationSidelink). In other cases, the RRC reconfiguration complete sidelink message (e.g., RRCReconfigurationCompleteSidelink) with an indication of the SL DRX configuration may be used for acknowledging explicitly that the SL DRX configuration included in the received RRC reconfiguration sidelink message (e.g., RRCReconfigurationSidelink), where the indication may contain the SL DRX configuration ID or index or a code value reserved or mapped for acknowledging the SL DRX configuration. In some cases, the RRC reconfiguration complete sidelink message (e.g., RRCReconfigurationCompleteSidelink) may also be used for indicating that the SL DRX configuration is not supported (e.g., using a code value configured or reserved), so that no more SL DRX configuration or reconfiguration is conducted.

In some aspects, instead of UE 804 confirming the configuration (e.g., as in operation 4), UE 804 may reject the configuration via a RRC reconfiguration failure sidelink message (e.g., RRCReconfigurationFailureSidelink), as illustrated in operation 5A. In some cases, the RRC reconfiguration failure sidelink message (e.g., RRCReconfigurationFailureSidelink) may be used for indicating implicitly the failure of SL DRX configuration included in the received RRC reconfiguration sidelink message (e.g., RRCReconfigurationSidelink) or for indicating explicitly the failure of SL DRX configuration included in the received RRC reconfiguration sidelink message (e.g., RRCReconfigurationSidelink) with a code value reserved or configured for SL DRX configuration failure and/or the SL DRX configuration ID or index or code point of LUT. In some cases, the RRC reconfiguration failure sidelink message (e.g., RRCReconfigurationFailureSidelink) may be used for rejecting implicitly that the SL DRX configuration included in the received RRC reconfiguration sidelink message (e.g., RRCReconfigurationSidelink). In some cases, the RRC reconfiguration failure sidelink message (e.g., RRCReconfigurationFailureSidelink) with an indication of the SL DRX configuration may be used for rejecting explicitly that the SL DRX configuration included in the received RRC reconfiguration sidelink message (e.g., RRCReconfigurationSidelink), where the indication may contain the SL DRX configuration ID or index or code point of LUT or a code value reserved or mapped for rejecting an SL DRX configuration. In some cases, the RRC reconfiguration failure sidelink message may include an indication of a preferred SL DRX configuration (e.g., sl-drx-config2, or sl-drx-config-id2 or sl-drx-config-index2 of sl-drx-config-list2 or codepont2) by UE 804, as illustrated. At operations 6A and 7A, UE 802 may consider the preferred SL DRX configuration (e.g., sl-drx-config2, or sl-drx-config-id2 or sl-drx-config-index2 of sl-drx-config-list2 or codepoint2) received from UE 804 and may reconfigure based on the preferred SL DRX configuration via the RRC reconfiguration sidelink message (e.g., RRCReconfigurationSidelink) and may receive an RRC reconfiguration complete sidelink message (e.g., RRCReconfigurationCompleteSidelink) from UE 804 for accepting, as illustrated. In some aspects, UE 804 may reject the configuration with reasons such as SL DRX cycle length to be increased or decreased (e.g., a preferred SL DRX cycle length) to align with its other SL DRX configuration(s) or for its power saving or latency specifications, SL DRX on duration to be increased or decreased (e.g., a preferred SL DRX On timer value) for different Tx UEs or data packet sizes, or SL DRX offset to be shifted with overlapping or non-overlapping with its other SL DRX configuration(s) (e.g., a preferred SL DRX Offset value), as examples, and UE 802 may adjust the SL DRX configuration accordingly and reconfigures the SL DRX with adjusted SL DRX configuration.

In certain aspects, UE 804 may indicate the preferred SL DRX configuration via a separate message than the RRC reconfiguration failure sidelink message (e.g., RRCReconfigurationFailureSidelink). For example, UE 804 may use UE Assistance Information Sidelink message with the preferred SL DRX configuration after the RRC reconfiguration failure sidelink message (e.g., RRCReconfigurationFailureSidelink), and UE 802 may reconfigure the SL DRX configuration with the preferred SL DRX configuration received (e.g., transmit RRCReconfigurationSidelink with the preferred SL DRX). As another example, at operation 5B, the UE 804 rejects the configuration, and at operation 6B, UE 804 transmits an RRC reconfiguration sidelink message indicating the preferred SL DRX configuration (e.g., RRCReconfigurationSidelink with sl-drx-config2, or sl-drx-config-id2 or sl-drx-config-index2 of sl-drx-config-list2 or codepoint2). At operations 6B and 7B, UE 804 reconfigures with the preferred SL DRX configuration, as illustrated. At operation 8, the UEs 802, 804 start a SL DRX cycle with the SL DRX configuration negotiated for the unicast communication from UE 802 to UE 804.

Similarly, UE 804 may determine an SL DRX configuration based on SL DRX information or candidate SL DRX configuration(s) received from higher layer or the paired UE (e.g., UE 802) and then may transmit an RRC reconfiguration sidelink message (e.g., RRCReconfigurationSidelink) with the SL DRX configuration for the unicast communication from UE 804 to UE 802 during or after establishing a PC5 RRC connection with UE 802.

In some aspects, UE 802 may start another application using the PC5 link established with associated SL DRX info or SL DRX configuration(s), or may be triggered by the higher layer or by a UE's request (e.g., a PC5 RRC message to indicate a (re-)configuration request from UE 804, for example, using UE Assistance Information Sidelink message optionally with preferred SL DRX information or a preferred SL DRX configuration(s) such as sl-drx-config3, or sl-drx-config-id3 or sl-drx-config-index3 of sl-drx-config-list3 or codepoint3 or with one or more preferred SL DRX parameters such as SL DRX cycle length, SL DRX Offset, SL DRX On timer value, SL DRX Inactivity timer value, SL DRX HARQ RTT timer, SL DRX HARQ Retransmission timer, etc. carried on PC5 RRC message at operation 9B) for reconfiguration due to data traffic, QoS specification or priority, power saving goals, sidelink loading or congestion level, location, communication range, road situation, battery power level, etc., which results in another adjustment of the SL DRX configuration, at operation 9A. In other words, the UE 802 may receive, from the higher layer of the UE 802 or an application or the paired UE 804 (e.g., at operation 9B), an indication for an SL DRX configuration with SL DRX information or candidate or preferred SL DRX configuration(s). At operations 10 and 11, an SL DRX configuration (e.g., sl-drx-config3, sl-drx-config-id3 or sl-drx-config-index3) may be configured (e.g., based on the SL DRX information or preferred SL DRX configuration or SL DRX parameter(s) from the application, the higher layer or the paired UE 804) for the unicast communication from UE 802 to UE 804 by transmitting an RRC reconfiguration sidelink message (e.g., RRCReconfigurationSidelink) indicating the SL DRX configuration and receiving a confirmation of the SL DRX configuration via the RRC reconfiguration complete sidelink message (e.g., RRCReconfigurationCompleteSidelink), as illustrated. At operation 12, the UEs 802, 804 may start a SL DRX cycle with the SL DRX configuration (e.g., sl-drx-config3, sl-drx-config-id3 or sl-drx-config-index3).

Similarly, UE 804 may determine an SL DRX (re-)configuration triggered by a new application using the PC5 link established or by higher layer or by a UE's request (e.g., an indication for (re-)configuration from UE 804, for example, via a UE Assistance Information message with SL DRX information or a preferred SL DRX configuration or with one or more preferred SL DRX parameters such as SL DRX cycle length, SL DRX Offset, SL DRX On timer value, SL DRX Inactivity timer value, SL DRX HARQ RTT timer, SL DRX HARQ Retransmission timer, etc.) and then may transmit an RRC (re-) configuration sidelink message (e.g., RRCReconfigurationSidelink) with the SL DRX configuration for the unicast communication from UE 804 to UE 802.

FIG. 8B illustrates a protocol for configuring or reconfiguring a SL DRX for one or more groupcast communications (e.g., coordinating SL DRX configuration(s) among group members) which may be managed by application layer, V2X service layer or access stratum (AS) layer via a group management function, in accordance with certain aspects of the present disclosure. The group management function, may include, for example, group ID (e.g., layer 2 destination ID for a groupcast) and group member ID generation, group forming and releasing, group announcement and discovery, group lead election, joining and leaving a group for a UE, security such as authentication and authorization, group traffic management, information such as security keying for establishing PC5 group common signaling radio bearer(s) (SRB(s)) for lower layer messages (e.g., PC5 RRC message), information such as priority for data logic channel (e.g., sidelink traffic channel (STCH)) and mapping for group common or dedicated control logic channel (e.g., sidelink control channel (SCCH) or sidelink dedicated control channel (SDCCH) for a group) at a lower layer (e.g., MAC layer), etc. At blocks 1A and 1B, a UE 812 and UEs 814 are pre-configured with SL DRX information (e.g., referred to herein as sl-drx-info) or one (e.g., sl-drx-config1a and sl-drx-config1b respectively) or more candidate SL DRX configurations (e.g., sl-drx-config-list1a and sl-drx-config-list1b respectively), for example, one or more candidate SL DRX configurations based on QoS specifications (e.g., associated or mapped with QoS profile(s) or QoS parameters, for example via a look-up table (LUT), for different QoS flows associated to one or more services or service types). UEs 812, 814 may be part of a group for groupcast communication, wherein UE 812 is the group or cluster lead. At blocks 2A and 2B, each of the UE 812 and UEs 814 start a first application (e.g., a service or service type with one or more QoS flows), receive at least one cast type (e.g., groupcast as exemplified herein) and the associated groupcast ID (e.g., a layer 2 (L2) destination ID for the groupcast), associated SL DRX information, or candidate SL DRX configuration(s) (e.g., associated or mapped with the QoS profile or QoS parameters for the service or service type or the L2 destination ID) from a higher layer, as illustrated.

UE 812 and UEs 814 may transmit a PC5-groupcast (herein PC5-G) message on a SL signaling radio bearer for a group (herein SL SRBg) mapped or controlled by access-stratum (AS) layer with the group information received from higher layer's group management function. At operation 2, UE 812 may determine an SL DRX configuration based on SL DRX information (e.g., QoS profile or QoS parameters) or candidate SL DRX configuration(s) (e.g., associated or mapped with QoS profile or QoS parameters via a LUT) received from a higher layer and then transmit a SL DRX configuration (e.g., sl-drx-config1, or sl-drx-config-id1 or sl-drx-config-index1 of sl-drx-config-list1 or codepoint1) via a groupcast message carried on PC5-G on the established SL SBRg. The SL SBRg may be a group common or shared signaling radio bearer with an established AS security or V2X service security managed by higher layer's group management function. At operation 3, UEs 814 may accept the SL DRX configuration (e.g., sl-drx-config1, or sl-drx-config-id1 or sl-drx-config-index1 of sl-drx-config-list1 or codepoint1) via a groupcast message such as PC5-G Complete message (e.g., PC5-G-complete message on SL SRBg) or a PC5 RRC unicast message if PC5 link with UE 812 has established, or at operation 3A, may reject the SL DRX configuration via a groupcast message such as PC5-G Failure message (e.g., PC5-G-failure message on SL SRBg) or a PC5 RRC unicast message if PC5 link with UE 812 has established. In some cases, the PC5-G Failure message (e.g., PC5-G-failure message on SL SRBg) may be used for rejecting implicitly that the SL DRX configuration included in the received PC5-G message. In some cases, the PC5-G Failure message with an indication of the SL DRX configuration may be used for rejecting explicitly that the SL DRX configuration included in the received PC5-G message, where the indication may contain the SL DRX configuration ID or index or code point of SL DRX LUT associated or mapped with QoS profile or QoS parameters or a code value reserved or mapped for rejecting an SL DRX configuration. As illustrated, the PC5-G Failure message may indicate a preferred SL DRX configuration (e.g., sl-drx-config2, or sl-drx-config-id2 or sl-drx-config-index2 of sl-drx-config-list2 or codepoint2). At operations 3B and 3C, UE 802 and UEs 814 may configure the preferred SL DRX configuration (e.g., sl-drx-config2, or sl-drx-config-id2 or sl-drx-config-index2 of sl-drx-config-list2 or codepoint2) via the PC5-G message and PC5-G Complete messages from the UEs 814, as illustrated. In some aspects, UE 804 may reject the configuration with one or more preferred SL DRX parameters such as SL DRX cycle length, SL DRX On timer value, SL DRX Inactivity timer value, etc. At operation 4, the UE 812 and UEs 814 begin a SL DRX cycle with the second SL DRX configuration (e.g., sl-drx-config2, or sl-drx-config-id2 or sl-drx-config-index2 of sl-drx-config-list2 or codepoint2).

In some aspects, UE 812 may start another application with associated SL DRX info or SL DRX configuration(s), or may be triggered by the higher layer or by a UE's request (e.g., an indication for (re-)configuration from one of UEs 804, for example, using UE Assistance Information Sidelink as a PC5 RRC unicast message or as a PC5-G groupcast message optionally with preferred SL DRX information or SL DRX configurations such as sl-drx-config3, or sl-drx-config-id3 or sl-drx-config-index3 of sl-drx-config-list3 or sl-drx-config-codepoint3 carried on PC5-G at operation 5B) for reconfiguration due to data traffic, QoS specification or priority, power saving specification, sidelink loading or congestion level, location, communication range, road situation, battery power level, etc., which results in that the SL DRX configuration may be reconfigured at operation 5A. For example, at operation 6, UE 812 may indicate a new SL DRX configuration (e.g., sl-drx-config3, sl-drx-config-id3 or sl-drx-config-index3 or sl-drx-config-codepoint3) via a PC5-G message, and receive PC5-G Complete messages from UEs 814 at operation 7, as illustrated. At operation 8, the UEs 812, 814 may start SL DRX cycle with the updated SL DRX configuration. In some aspects, the responses from UEs 814 to UE 812 such as operation 3, 3A, 3C and 7 may also be unicast if there is a PC5 RRC pair link between a UE of UEs 814 and UE 812. In some aspects, the responses for confirming or rejecting from UEs 814 to UE 812 may be from each of UEs 814 (e.g., operation 3, 3C and 7 for confirming a SL DRX configuration) or from at least one of UEs 814 (e.g., operation 3A for rejecting a SL DRX configuration).

FIG. 8C illustrates a protocol for configuring or reconfiguring a SL DRX for one or more broadcast or connectionless groupcast communications to coordinate SL DRX configuration(s) among UEs using the broadcast(s) or connectionless groupcast(s), in accordance with certain aspects of the present disclosure. Connectionless groupcast generally refers to a group of UEs in communication without an established PC5 RRC connection for the group. For example, a connectionless group may be formed by distance or proximity without higher layer's group management as described for FIG. 8B. At blocks 1A and 1B, the UE(s) 822 (e.g. a roadside unit (RSU), a cluster or proximity lead, a scheduling UE, or a TxUE) and UEs 824 may be preconfigured with one (e.g., sl-drx-config1a and sl-drx-config1b respectively) or more candidate SL DRX configurations (e.g., sl-drx-config-list1a and sl-drx-config-list1b respectively), for example, one or more candidate SL DRX configurations based on QoS specifications (e.g., associated or mapped with QoS profile(s) or QoS parameters, for example via a LUT, for different QoS flows associated to one or more services or service types). At blocks 2A and 2B, a first application (e.g., a service or service type with one or more QoS flows) may be started, at least one cast type (e.g., broadcast as exemplified herein) and the associated broadcast ID (e.g., a layer 2 (L2) destination ID for the broadcast), associated SL DRX information, or candidate SL DRX configuration(s) (e.g., associated or mapped with the QoS profile or QoS parameters for the service or service type or the L2 destination ID) may be received from a higher layer, as illustrated. At operation 3, UE 822 may determine an SL DRX configuration based on SL DRX information (e.g., QoS profile or QoS parameters) or candidate SL DRX configuration(s) (e.g., associated or mapped with QoS profile or QoS parameters via a LUT) received from higher layer and then transmit a SL DRX configuration (e.g., sl-drx-config1, or sl-drx-config-id1 or sl-drx-config-index1 of sl-drx-config-list1 or sl-drx-config-codepoint1) via SL system information (herein SL-SI) or PC5-RRC common message (herein PC5-RRC-common) on a common signaling radio bearer (SRB) such as SL SRBO or SL SRBO-like. The SL-SI may be mapped to a broadcast control logic channel in MAC layer such as sidelink broadcast control channel (SBCCH) or to a common control logic channel in MAC layer such as sidelink common control channel (SCCCH). The PC5-RRC-common may be mapped to a common control logic channel in MAC layer such as a SCCCH. Optionally, UEs 824 may confirm or reject the configuration via PC5-RRC-common message with preferred SL DRX information or preferred SL DRX configuration or preferred SL DRX parameter(s) as exemplified in FIG. 8A and 8B. At operation 4, SL DRX cycle may be started with the SL DRX configuration.

In some cases, UE 822 may start another application with associated SL DRX info or SL DRX configuration(s), or may be triggered by the higher layer or by a UE's request (e.g., an indication for (re-)configuration from one of UEs 824, for example, using UE Assistance Information Sidelink as a PC5 RRC unicast message or as a PC5-RRC-common broadcast message optionally with preferred SL DRX information or preferred SL DRX configuration such as sl-drx-config2, or sl-drx-config-id2 or sl-drx-config-index2 of sl-drx-config-list2 or sl-drx-config-codepoint2 carried on PCS RRC common at operation 5B) for reconfiguring the SL DRX due to the reasons described with respect to FIGS. 8A and 8B. For example, at operation 6, SL DRX configuration may be reconfigured via SL SI or PC5-RRC common on SL SRBO or SRBO-like (e.g. reconfigured to sl-drx-config2, sl-drx-config-id2 or sl-drx-config-index2 or sl-drx-config-codepoint2), as illustrated, At operation 7, SL DRX cycle may begin with the updated SL DRX configuration.

As exemplified in FIGS. 8A, 8B and 8C, a higher layer may manage or control SL DRX information or SL DRX configurations for service(s) using broadcast, group(s) using groupcast, or UE pair(s) using unicast. However, SL DRX information or SL DRX configurations at a lower layer (e.g., SL DRX with RRC configuration) may also be indicated to higher layer's data traffic management for different services or communications to accommodate different SL DRX configurations at the lower layer for improving power saving as well as meeting performance specifications with balanced traffic load on sidelink. For example, the higher layer may form data traffic with a different latency specification into SL DRX configurations with different SL DRX cycle lengths, respectively. For another example, the higher layer may form broadcast traffics per one or multiple SL DRX configurations common for all UEs, or a groupcast traffic per the group's SL DRX configuration.

As described herein, a UE participating in different sidelink communications may have multiple sidelink DRX configurations for different applications or services, different groups, or different UE pairs. Therefore dynamically switching or selecting sidelink DRX configuration is important for both power saving and QoS specifications. For an application or service, the higher layer may trigger a SL DRX enabled or disabled or reconfigured as exemplified previously via different PC5 RRC messages.

In some aspects, a sidelink MAC CE or sidelink control information (SCI) may also be used for semi-persistently activating, deactivating an SL DRX configuration, or switching to a different sidelink DRX configuration by an RSU, a group lead, cluster lead, scheduling UE or a Tx UE when under certain condition(s) or criteria such as for an application or service, for a sidelink communication, for a data traffic change, for an event or road situation, for a location, for a communication range, for a latency or reliability or power saving specification, for a battery power level, for a sidelink loading or congestion level, etc. For example, one or more SL DRX configurations may be activated (or selected) or deactivated by a MAC CE or an SCI (e.g., with activation or deactivation indication and fields for a set of SL DRX configuration(s) to be activated or deactivated respectively if more than one SL DRX configurations (e.g., ACTIVATE or DEACTIVATE {sl-drx-config1, sl-drx-config2, . . . } or {sl-drx-config-id1, sl-drx-config-id2, . . . } or {sl-drx-config-index1, sl-drx-config-index2, . . . } or {sl-drx-config-codepoint1, sl-drx-config-codepoint2,... } or sl-drx-config-list1). For example, one or more SL DRX configuration(s) may be switched via SCI or MAC CE explicitly deactivating the current set of SL DRX configuration(s) and then activating a new set of SL DRX configuration(s) or implicitly deactivating the current set of SL DRX configuration(s) by activating a new set of SL DRX configuration(s).

In some aspects, an RSU, a group lead, a cluster lead, a scheduling UE or a Tx UE may dynamically activate or select, deactivate or switch one or more sidelink DRX configurations under certain condition(s) or criteria described herein, e.g., via a wake up indication carried on SCI or MAC CE in a slot configured or reserved prior to one or more SL DRX On durations. For example, the wake-up indication may include fields for a set of one or more SL DRX configurations {sl-drx-config1, sl-drx-config2, . . . } or {sl-drx-config-id1, sl-drx-config-id2, . . . } or {sl-drx-config-index1, sl-drx-config-index2, . . . } or {sl-drx-config-codepoint1, sl-drx-config-codepoint2, . . . } or sl-drx-config-list1 for different Tx UEs or Rx UEs or different communications respectively within one or more SL DRX cycles if indicated.

In some aspect, one or more SL DRX may be activated, deactivated or switched for a proximity area or zoning group, e.g., with location or zone or zone group ID indicated in an activation or deactivation MAC CE or SCI or indicated in a wake-up indication carried on MAC CE or SCI. For distance based, an RX UE may decide to apply an indicated SL DRX change or not based on the distance from the Tx UE, e.g., calculating the distance between Rx UE's known location and Tx UE's location indicated in activation or deactivation MAC CE or SCI or wake-up indication MAC CE or SCI and determining to apply the SL DRX change if the calculated distance is not larger than a configured communication range or indicated communication range in activation or deactivation MAC CE or SCI or wake-up indication MAC CE or SCI.

In some aspects, an RSU, a group lead, a cluster lead, a scheduling UE or a Tx UE may end UE (s)' active state in SL DRX On duration or extended active phase (e.g., extended with SL DRX Inactivity timer or SL DRX HARQ retransmission timer) via an SL DRX command carried on PC5 MAC CE for a certain data traffic or for a certain system loading condition, for example, to reduce sidelink load or interference. The SL DRX command may include the priority of the traffic, SL DRX configuration if more than one, or number of SL DRX cycles with Rx UEs' active state turned off.

In some aspect, an SL DRX configuration may be associated with a resource pool, Tx and Rx UEs may select a resource pool with an SL DRX configuration associated for transmission and reception respectively. For example, a UE may transmit an indication of a sidelink DRX configuration by indicating a resource pool associated with the sidelink DRX configuration. For example, UEs may exchange discovery messages via a discovery resource pool which is structured with SL DRX configuration for discovery on sidelink.

For resource allocation mode 1, a Tx UE is under a BS's control, but Rx UE may not be under the BS's control, as described herein. In this case, the Tx UE may forward the sidelink DRX configuration or reconfiguration for different communications, such as unicast, groupcast and broadcast. Thus, SL DRX may be managed by the network (e.g., BS or gNB). A Tx UE may receive one or more SL DRX configurations or reconfigurations from the network and forward the received SL DRX configurations or reconfigurations for different communication to the Rx UE(s) using RRCReconfigurationSidelink message for sidelink unicast, PC5-G message on SL SRBg for sidelink connection based groupcast, or SL-SI or PC5-RRC-common on a common SL SBR such as SL SBR0 or SL SRB0-like for broadcast or connectionless groupcast, as described previously for FIGS. 8A, 8B and 8C.

In some cases, one or more SL DRX configurations may be activated, deactivated, or selected by the network (e.g., BS or gNB) via MAC CE or DCI (e.g. DCI 3). In some cases, one or more SL DRX configurations may be indicated in a wake up DCI from the network. In some cases, an SL DRX configuration may be implicitly selected via a resource pool indication in DCI (e.g. DCI 3) from the network.

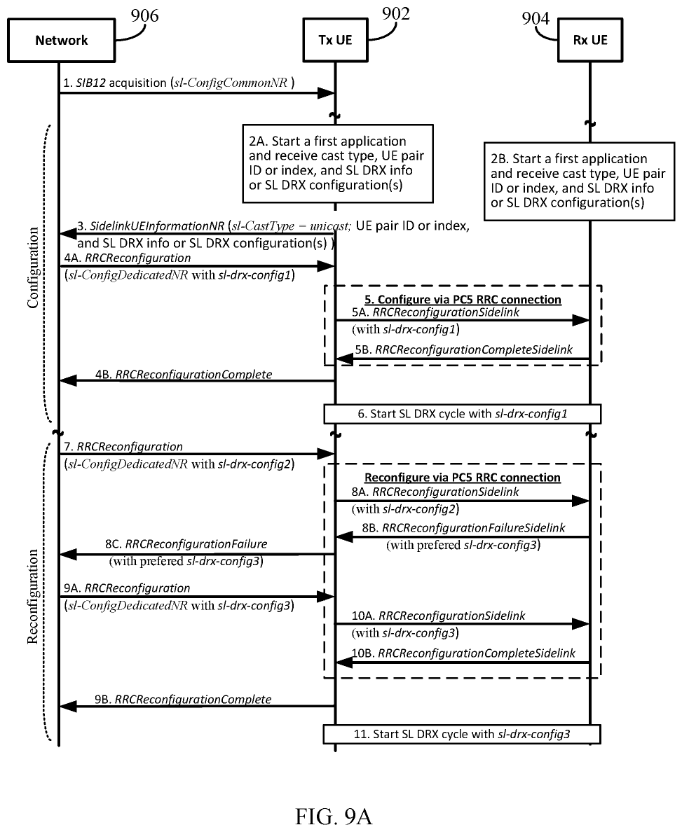

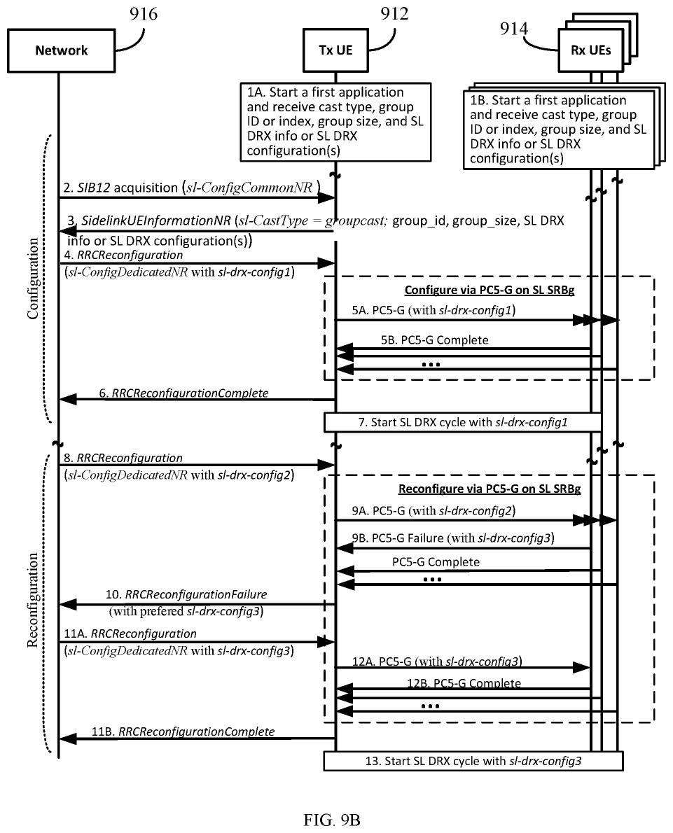

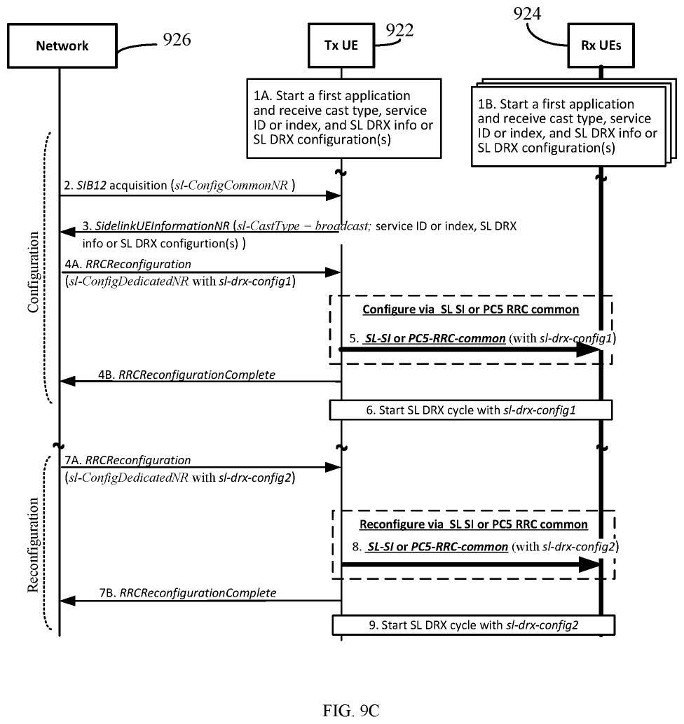

FIG. 9A illustrates a network controlled protocol for configuring or reconfiguring a SL DRX for one or more unicast communications (e.g., coordinating SL DRX configuration(s) between a UE pair), in accordance with certain aspects of the present disclosure. At operation 1, UE 902 and/or UE 904 acquires a system information block (e.g., SIB12) (e.g., sl-ConfigCommonNR) which may contain information for sidelink communications including SL DRX supporting information (e.g., if the network or BS 906 supports SL DRX operation or not) as well as SL DRX information. At blocks 2A and 2B, UE 902 and UE 904 start a first application and receive at least one cast type (e.g., unicast as exemplified herein), UE pair or link ID or index or UE source and/or destination ID, associated SL DRX information or candidate SL DRX configurations associated or mapped with QoS profile or QoS parameters for the PC5 connection or for the service(s) or service types with the PC5 connection from the higher layer or paired UE, and UE 902 and UE904 may establish PC5 RRC connection accordingly. UE 902 or UE 904 may establish RRC connection with the network (e.g., base station). At operation 3, the UE 902 sends sidelink UE information message (e.g., SidelinkUEInformationNR) or UE assistance information for sidelink message to the BS 906 indicating a sidelink cast type (sl-CastType) set as unicast and the related UE pair or link ID or index or pair of L2 source ID and destination ID or L2 destination ID, associated SL DRX information (e.g., QoS profile or parameters, traffic pattern, power saving, etc.) or preferred SL DRX configuration(s) received from the higher layer or UE 904 during or after the PC5 RRC connection establishment. At operation 4A, the BS decides an SL DRX configuration based on the input from UE 902 (e.g., Tx UE's sidelink UE information message or UE assistance information for sidelink message) and sends the SL DRX configuration for sidelink unicast communication from UE 902 to UE 904 (e.g., sl-drx-config1 under sl-ConfigDedicateNR) via an RRC reconfiguration message (e.g., RRCReconfiguration), and at operation 4B, may receive a confirmation from the UE 902 via the RRC reconfiguration complete message (e.g., after confirmed with the paired UE 904 at operation 5B), as illustrated. At operation 5A, the UE 902 forwards the received SL DRX configuration (e.g., sl-drx-config1) to UE 904 via an RRC reconfiguration sidelink (e.g., RRCReconfigurationSidelink) message, and operation 5B may receive a confirmation of the configuration via the RRC reconfiguration complete sidelink (e.g., RRCReconfigurationCompleteSidelink) message. At operation 6, UEs 902, 904 start a SL DRX cycle per the SL DRX configuration (e.g., sl-drx-config1) for sidelink unicast communication from UE 902 to UE 904. In some aspects, the UE 904 may reject the SL DRX configuration received from UE 902 (e.g., using RRCReconfigurationFailureSidelink message as described for FIG. 8A), and then UE 902 may send, for example, RRCReconfigurationFailure message to BS 906, for rejecting accordingly the SL DRX configuration received from BS 906. In some aspects, the UE 902 may send, for example, RRCReconfigurationFailure message to BS 906, for rejecting the SL DRX configuration received from BS 906, and may not forward the SL DRX configuration to its paired UE 904.

Similarly, UE 904 may received an SL DRX configuration from the associated base station (e.g. gNB) based on the SL DRX information or preferred SL DRX configuration(s) contained in sidelink UE information message or UE assistance information for sidelink message from UE 904, forward the received SL DRX configuration to UE 902, and start a SL DRX cycle per the SL DRX configuration for the sidelink unicast communication from UE 904 to UE 902.

At operation 7, the BS may determine to reconfigure the SL DRX (e.g., a dedicated RRC message such as RRCReconfiguration message with sl-drx-config2) for alignment between Uu and PC5 traffic based on network loading and/or indication from Tx UE 902 (e.g., sidelink UE information message or UE assistance information for sidelink message from Tx UE 902 as exemplified at operation 3), for example, if the Tx UE does not support simultaneous transmissions or receptions on both Uu and PC5 interface. At operation 8A, the reconfiguration of the SL DRX is forwarded to the Rx UE 904 (e.g., RRCReconfigurationSidelink message with sl-drx-config2), and at operation 8B, the reconfiguration may be rejected by the Rx UE 904 (e.g., RRCReconfigurationFailureSidelink message) along with an indication of the Rx UE's SL DRX information or preferred SL DRX configuration (e.g., sl-drx-config3), as illustrated. At operation 8C, Rx UE's SL DRX information or RX UE's preferred SL DRX configuration may be forwarded to the BS 906 by Tx UE 902 (e.g., RRCReconfigurationFailure message with sl-drx-config3). At operations 9A and 9B, the BS reconfigures the SL DRX with the preferred configuration (e.g., a dedicated RRC message such as RRCReconfiguration message with sl-drx-config3), as illustrated. At operations 10A, 10B, the Tx UE 902 forwards the SL DRX reconfiguration to the Rx UE 904 (e.g., RRCReconfigurationSidelink message with sl-drx-config3) and receives a confirmation (e.g., RRCReconfigurationCompleteSidelink message) thereof, and at operation 11, begin the SL DRX cycle with the updated SL DRX configuration (e.g., sl-drx-config3) for sidelink unicast communication from Tx UE 902 to Rx UE 904, as illustrated.

FIG. 9B illustrates a network controlled protocol for configuring or reconfiguring a SL DRX for one or more groupcast communications (e.g., coordinating SL DRX configuration(s) among groupcast communications), in accordance with certain aspects of the present disclosure. At blocks 1A and 1B, a first application is started and each of the UEs 912, 914 receive cast type (e.g., groupcast as exemplified herein), group ID or index (e.g., L2 destination ID for the groupcast), group size, SL DRX information or candidate SL DRX configuration(s) associated or mapped with QoS profile or QoS parameters for the group (e.g., L2 destination ID) or for the service(s) or service types with the group from a higher layer. UE 912 and UE 914 may join the groupcast accordingly before or after the system information acquisition (e.g., SIB12 acquisition). At operation 2, the UE 912 (which may be a group lead, cluster lead or a Tx UE) and/or UEs 914 may receive SIB12 (e.g., sl-ConfigCommonNR) which may contain information for sidelink communications including SL DRX information (e.g., if the network or BS 916 supports SL DRX operation or not, candidate SL DRX configurations association or mapping with QoS profile or QoS parameters if SL DRX is supported) from the BS 916, and UE 912 and/or UE 914 may establish RRC connection with the network (e.g., with respective base station(s)). At operation 3, the UE 912 sends the sidelink UE information (e.g., SidelinkUEInformationNR) or UE assistance information for sidelink message with SL cast type (sl-CastType) set as groupcast, HARQ feedback (e.g., disable or not, HARQ ACK/NACK or NACK only feedback if enabled), group ID or index (e.g., L2 destination ID for the groupcast), group size, associated SL DRX information, or preferred SL DRX configuration(s) (e.g., associated or mapped with QoS profile or QoS parameters for the groupcast L2 destination ID or for the service or service type of the groupcast) to the BS 916. At operation 4, the BS decides an SL DRX configuration based on input from UE 912 (e.g., sidelink UE information message or UE assistance information for sidelink message) and sends the SL DRX configuration (e.g., sl-drx-config1 under sl-ConfigDedicateNR for the groupcast) via an RRC reconfiguration (e.g., a dedicated RRC message such as RRCReconfiguration) message.

At operation 5A, the UE 912 groupcasts the received SL DRX configuration to the UEs 914 within the group via a PC5-G message (e.g., PC5-G with the group AS security from the higher layer) via a group common or shared sidelink group signaling radio bearer (SL SRBg). At operations 5B, each UE of UEs 914 may send PC5-G Complete to confirm or PC5-G Failure to reject the configuration, or UEs 914 may only send PC5-G Failure to reduce the message overhead. At operation 6, the UE 912 confirms the SL DRX configuration to the BS 916 (e.g., RRCReconfigurationComplete message). At operation 7, the SL DRX cycle is started per the SL DRX configuration (e.g., sl-drx-config1).

In some aspects, at operation 8, the BS reconfigures SL DRX (e.g., a dedicated RRC message such as RRCReconfiguration message with sl-drx-config2) for the alignment between SL DRX configuration and UE's Uu DRX configuration as an example. At operation 9A, the UE 912 indicates the SL DRX reconfiguration (e.g. PC5-G message with sl-drx-config2) to the UEs 914, as illustrated, and at operation 9B, the reconfiguration may be rejected by one or more of the UEs 914 via the PC5-G failure message (e.g. PC5-G-failure message with sl-drx-config2). The one or more of the UEs 914 rejecting the reconfiguration may indicate the SL DRX information or preferred configuration (e.g., sl-drx-config3) in the PC5-G failure message, as illustrated. At operation 10, the UE 912 forwards the rejection to the BS 916 (e.g., RRCReconfigurationFailure message with sl-drx-config3). At operation 11A, the BS reconfigures the SL DRX with the preferred configuration, and at operation 11B, may receive an RRC reconfiguration complete message from the UE 912 as confirmation. At operation 12A, the UE 912 forwards the SL DRX reconfiguration to the UEs 914, and at operation 12B, receives PC5-G complete messages from the UEs 914 accepting the reconfiguration. Thus, at operation 13, the UEs may begin the SL DRX cycle with the updated SL DRX configuration (e.g., sl-drx-config3).

In some cases, the UE 912 and/or UE 914 conduct system information (SI) acquisition and establish RRC connection with the network (e.g., its gNB or base station) after joining a groupcast. In some cases, the UE 912 and/or UE 914 conduct system information (SI) acquisition and establish RRC connection with the network (e.g., its gNB or base station) before joining a groupcast.

FIG. 9C illustrates a network controlled protocol for configuring or reconfiguring a SL DRX for one or more broadcast or connectionless groupcast communications (e.g., coordinating SL DRX configuration(s) among broadcast or connectionless groupcast communications), in accordance with certain aspects of the present disclosure. At blocks 1A and 1B, each of the UE 922 and UEs 924 start a first application and receive cast type (e.g., broadcast as exemplified herein), service ID or index (e.g., L2 destination ID for the groupcast or broadcast), SL DRX information or candidate SL DRX configuration(s) associated or mapped with QoS profile or QoS parameters for the groupcast or broadcast (e.g., L2 destination ID) or for the service(s) or service types with the groupcast or broadcast from the higher layer. UE 922 and UE 924 may join the groupcast or broadcast accordingly before or after the system information acquisition (i.e. SIB12 acquisition). At operation 2, the UE 922 and/or UE 924 acquires SIB12 (e.g., sl-ConfigCommonNR) which may contain information for sidelink communications including SL DRX information (e.g., if the network or BS 926 supports SL DRX operation or not, candidate SL DRX configurations association or mapping with QoS profile or QoS parameters if SL DRX is supported), and UE 922 and/or UE924 may establish RRC connection with the network (e.g., with the associated base station(s) (e.g., gNB)). In some cases, the SL DRX configuration (e.g., cell based or cell group based SL DRX configuration) may be indicated by the BS 926 in SIB12. If so, the operations 3 and 4 may be skipped. Otherwise, at operation 3, the UE 922 sends sidelink UE information (SidelinkUEInformationNR) or UE assistance information for sidelink message with SL cast type (sl-CastType) set as broadcast or groupcast, HARQ feedback (e.g., disable or not, HARQ ACK/NACK or NACK only feedback if enabled), service or group ID or index (e.g., L2 destination ID for the groupcast or broadcast), associated SL DRX information, or preferred SL DRX configuration(s) (e.g., associated or mapped with QoS profile or QoS parameters for the groupcast or broadcast L2 destination ID or for the service or service type of the groupcast or broadcast) to the BS 926. At operation 4A, the BS 926 decides an SL DRX configuration based on the input from UE 922 (e.g., sidelink UE information message or UE assistance information for sidelink message) and sends the SL DRX configuration for groupcast or broadcast (e.g., sl-drx-config1 under sl-ConfigDedicateNR) via the RRC reconfiguration (e.g., a dedicated RRC message such as RRCReconfiguration) message, and receives a confirmation from UE 922 at operation 4B, as illustrated. At operation 5, the UE 922 broadcasts the received SL DRX configuration to all UEs 924 via sidelink system information (SL-SI) or PC5 RRC common (PC5-RRC-common) message using a common or shared SBR (e.g., SBR0 or SBR0-like). At operation 6, the UE 922 and UEs 924 may begin a SL DRX cycle per the SL DRX configuration (e.g., sl-drx-config1). At operation 7A, the UE 922 may receive a reconfiguration (sl-drx-config2) of the SL DRX via the RRC reconfiguration message (e.g., a dedicated RRC message such as RRCReconfiguration), and at operation 7B, may provide a confirmation (e.g., RRCReconfigurationComplete) to the BS 926. At operation 8, the UE 922 forwards the updated SL DRX configuration (e.g., SL-SI or PC5-RRC-common on a common SL SRB) to the UEs 914, and at operation 9, begins the SL DRX cycle with the updated SL DRX configuration.

In some aspects, one or more of the UE 902, UE 912 and UE 912 may be a Relay UE for Rx UE 904, Rx UEs 914, and Rx UEs 924 respectively in FIGS. 9A, 9B and 9C. In this case, the Relay UE relays Rx UEs' RRC connection messages to the network (e.g., BS or gNB), and relays Rx UEs' SL DRX configuration message (e.g., a dedicated RRC message such as RRCReconfiguration message with sl-drx-config or sl-drx-config-id/ sl-drx-config-index of sl-drx-config-list) from the network within its PC5 RRC message as the container such as RRCReconfigurationSidlink for unicast, PC5-G for groupcast or PC5-RRC-common for broadcast respectively or includes Rx UEs' SL DRX configurations (e.g., sl-drx-config or sl-drx-config-id/ sl-drx-config-index of sl-drx-config-list) within its PC5 RRC message such as RRCReconfigurationSidlink for unicast, PC5-G for groupcast or PC5-RRC-common for broadcast respectively as illustrated. In this case, Relay UE's Uu DRX may be aligned with Relay UE's SL DRX with a certain timing relationship to facilitate proper timeline(s) for relaying between Uu interface and PC5 interface. For example, the Uu DRX cycle length may be the same as SL DRX cycle length, and the time gap between Uu DRX on duration and SL DRX on duration may follow certain relay process timeline(s) as well as QoS specification such as latency or packet delay budget.

As described herein, a UE participating in different sidelink communications may have multiple sidelink DRX configurations for different applications or services, different groups, or different UE pairs. Therefore, dynamically switching or selecting sidelink DRX configuration is important for both power saving and QoS specifications. As described herein, the SL DRX configuration or reconfiguration may be managed by the BS. If the BS configures multiple SL DRXs to a UE or UEs, the BS may select an SL DRX or switch from one SL DRX configuration to another SL DRX configuration by activation and deactivation via MAC CE or DCI (e.g. DCI 3 or similar) with an SL DRX configuration ID or index or code point of a KUT included in the MAC CE or DCI. If each resource pool is configured with a SL DRX configuration, then the BS may implicitly indicate the SL DRX configuration via a resource pool indication in DCI (e.g., DCI 3 or DCI 3-like) signaling. If the BS sends a wake up signal to UEs for power saving indication, the BS may also include the SL DRX configuration(s) for one or more SL DRX cycles in a wake up DCI (e.g., DCI 3 or DCI 3-like). In some aspects, the network may end UE (s)' active state in SL DRX On duration or extended active phase via an SL DRX command carried on Uu MAC CE for a certain data traffic, for example, to reduce sidelink load or interference. The SL DRX command forwarded by an RSU, group lead, cluster head, scheduling UE, Tx UE or relayed by a Relay UE on PC5 may include the priority of the traffic, SL DRX configuration if more than one, or number of SL DRX cycles with UEs' active state turned off.

If sidelink DRX configuration or reconfiguration is managed by the RSU, group lead, cluster head, scheduling UE, Tx UE or Relay UE, the sidelink MAC CE or SCI may be used for semi-persistently activating, deactivating, or switching a sidelink DRX configuration. For an RSU, group lead, cluster head, scheduling UE, Tx UE or a Relay UE, a wake up indication may be used for dynamically selecting a sidelink DRX configuration for one or more SL DRX cycles. In some aspects, the RSU, group lead, cluster head, scheduling UE, Tx UE or Relay UE may end UE (s)' active state via an SL DRX command carried on PC5 MAC CE for a certain data traffic, for example, to reduce sidelink load or interference. For a resource pool associated with a sidelink DRX configuration, Tx and Rx UEs may follow the SL DRX configuration associated with the resource pool for transmission and reception respectively, as described herein.

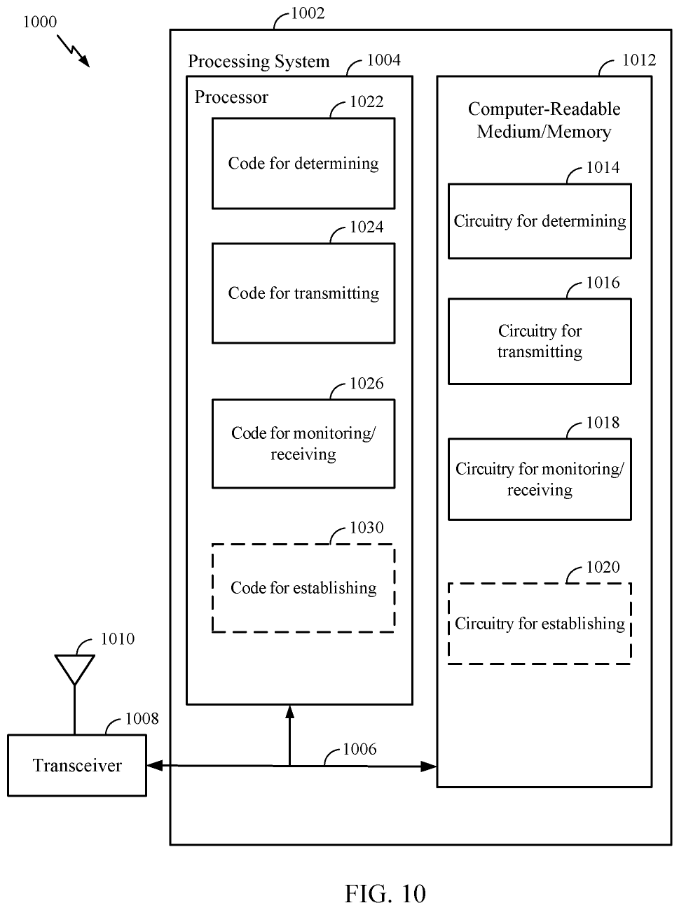

FIG. 10 illustrates a communications device 1000 that may include various components (e.g., corresponding to means-plus-function components) configured to perform operations for the techniques disclosed herein, such as the operations illustrated in FIGS. 5-6. The communications device 1000 includes a processing system 1002 coupled to a transceiver 1008. The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIGS. 5-6. In certain aspects, computer-readable medium/memory 1012 stores code 1014 for determining; code 1016 for transmitting; code 1018 for monitoring/receiving and code 1020 for establishing. In certain aspects, the processor 1004 has circuitry configured to implement the code stored in the computer-readable medium/memory 1012. The processor 1004 includes circuitry 1022 for determining; code 1024 for transmitting; code 1026 for monitoring/receiving and code 1030 for establishing.

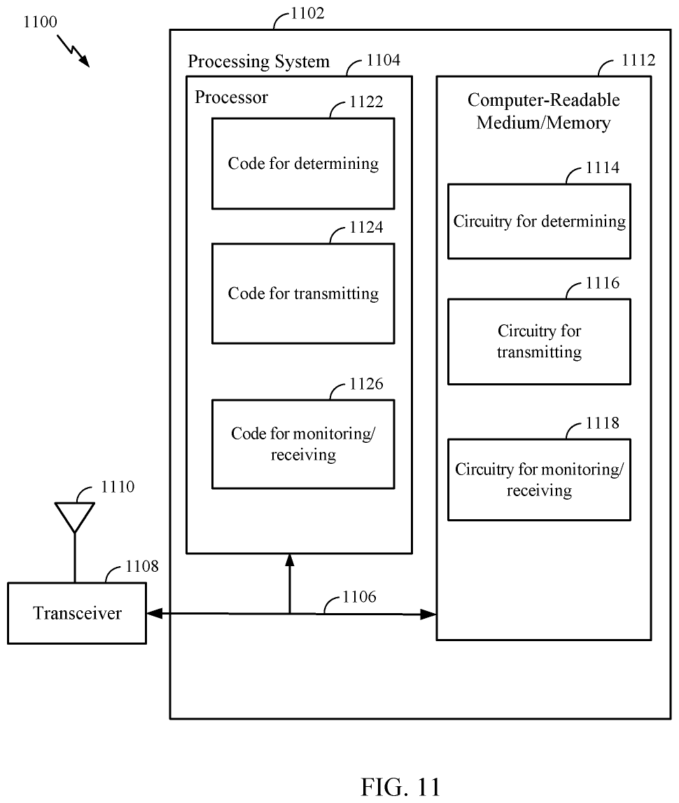

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108. The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7. In certain aspects, computer-readable medium/memory 1112 stores code 1114 for determining; code 1116 for transmitting; and code 1118 for monitoring/receiving. In certain aspects, the processor 1104 has circuitry configured to implement the code stored in the computer-readable medium/memory 1112. The processor 1104 includes circuitry 1122 for determining; code 1124 for transmitting; and code 1126 for monitoring/receiving.

### Example Aspects

Aspect 1. A method for wireless communication by a first user equipment (UE), comprising: determining information regarding communicating using sidelink discontinuous reception (DRX) or one or more sidelink DRX configurations for at least one application or service with at least one sidelink communication; determining at least one first sidelink DRX configuration based on the information or the one or more sidelink DRX configurations; transmitting, to at least one second UE, an indication of the at least one first sidelink DRX configuration for the at least one sidelink communication; and receiving, from the at least one second UE, an indication of whether the at least one first sidelink DRX configuration is accepted for the at least one sidelink communication.

Aspect 2. The method of aspect 1, wherein the information comprises an indication of whether the at least one sidelink communication is unicast, groupcast, or broadcast.

Aspect 3. The method of one of aspects 1-2, wherein the information indicates the at least one first DRX configuration.

Aspect 4. The method of one of aspects 1-3, further comprising establishing a radio resource control (RRC) connection with the at least one second UE, wherein the transmission of the indication of the first DRX configuration is via the RRC connection.

Aspect 5. The method of one of aspects 1-4, wherein receiving the indication of whether the at least one first DRX configuration is accepted comprises receiving, from the at least one second UE, a message rejecting the at least one first DRX configuration, the method further comprising: determining a second DRX configuration in response to the message rejecting the first DRX configuration; and transmitting an indication of the second DRX configuration.

Aspect 6. The method of aspect 5, wherein the message rejecting the at least one first DRX configuration comprises an indication of a preferred DRX configuration to be used, the determination of the second DRX configuration being based on the indication of the preferred DRX configuration.

Aspect 7. The method of one of aspects 5-6, further comprising receiving another message having an indication of a preferred DRX configuration to be used, the determination of the second DRX configuration being based on the indication of the preferred DRX configuration.

Aspect 8. The method of one of aspects 1-7, wherein the at least one sidelink communication using DRX comprising a communication among UEs using a service via broadcast, a communication among UEs of a group via groupcast, or a communication between a UE pair via unicast.

Aspect 9. The method of aspect 8, wherein the indication of the at least one first DRX configuration is transmitted to a group of UEs on a sidelink signaling radio bearer (SRB) established for the communication via groupcast.

Aspect 10. The method of one of aspects 8-9, wherein the indication of the at least one first DRX configuration is transmitted via a sidelink system information (SI) message or on a sidelink SRB established for the service.

Aspect 11. The method of one of aspects 1-10, further comprises communicating with the at least one second UE using the at least one first DRX configuration if the at least one first DRX configuration is accepted.

Aspect 12. The method of aspect 11, further comprising: receiving, from a higher layer of the first UE or from one of the at least one second UE, an indication that a current DRX configuration is to be reconfigured; determining a second DRX configuration based on the indication from the higher layer or from the at least one second UE; transmitting, to at least one second UE, an indication of the second DRX configuration; and receiving, from the at least one second UE, an indication of whether the second DRX configuration is accepted for the at least one sidelink communication.

Aspect 13. The method of one of aspects 1-12, further comprising: transmitting, to a base station, an indication of the information regarding communicating using the sidelink DRX; and receiving, from the base station, an indication of the at least one first DRX configuration to be used, the determination of the at least one first DRX configuration being based on the indication of the at least one first DRX configuration from the base station.

Aspect 14. The method of aspect 13, further comprising: receiving, from the base station, an indication of a second DRX configuration to be used; transmitting, to the at least one second UE, an indication of the second DRX configuration; and receiving, from the at least one second UE, an indication of whether the second DRX configuration is accepted for the at least one sidelink communication.

Aspect 15. The method of one of aspects 1-14, further comprising: determining a second sidelink DRX configuration to be selected or switched to; and transmitting an indication of the second sidelink DRX configuration in at least one sidelink control information (SCI) or a medium access control (MAC) control element (CE).

Aspect 16. The method of aspect 15, wherein the indication of the second sidelink DRX configuration comprises a wake up indication indicating to the at least one second UE to wake for reception of data.

Aspect 17. The method of one of aspects 15-16, wherein transmitting the indication of the second sidelink DRX configuration comprises indicating a resource pool associated with the second sidelink DRX configuration.

Aspect 18. A method for wireless communication by a first user equipment (UE), comprising: receiving, from a second UE, an indication of at least one first sidelink discontinuous reception (DRX) configuration for at least one application or service to be used for at least one sidelink communication using sidelink DRX; determining whether the at least one first sidelink DRX configuration is acceptable for the at least one sidelink communication using sidelink DRX; and transmitting, to the second UE, an indication of whether the at least one first sidelink DRX configuration is accepted for the at least one sidelink communication based on the determination.

Aspect 19. The method of aspect 18, further comprising establishing a radio resource control (RRC) connection with the second UE, wherein the reception of the indication of the first DRX configuration is via the RRC connection.

Aspect 20. The method of one of aspects 18-19, wherein transmitting the indication of whether the at least one first DRX configuration is accepted comprises transmitting, to the second UE, a message rejecting the at least one first DRX configuration, the method further comprising receiving an indication of a second DRX configuration in response to the message rejecting the first DRX configuration.

Aspect 21. The method of aspect 20, wherein the message rejecting the at least one first DRX configuration comprises an indication of a preferred DRX configuration to be used in response to the rejection the first DRX configuration.

Aspect 22. The method of one of aspects 20-21, further comprising transmitting another message having an indication of a preferred DRX configuration to be used in response to the rejection the first DRX configuration.

Aspect 23. The method of one of aspects 18-22, wherein the communication using DRX comprising a communication among UEs using a service via broadcast, a communication among UEs of a group via groupcast, or a communication between a UE pair via unicast.

Aspect 24. The method of aspect 23, wherein the indication of the at least one first DRX configuration is transmitted on a sidelink signaling radio bearer (SRB) established for the communication via groupcast.

Aspect 25. The method of one of aspects 23-24, wherein the indication of the at least one first DRX configuration is transmitted via a sidelink system information (SI) message or on a sidelink SRB established for the service.

Aspect 26. The method of one of aspects 18-25, further comprises communicating with the second UE using the at least one first DRX configuration if the at least one first DRX configuration is accepted.

Aspect 27. The method of aspect 26, further comprising: receiving, from the second UE, an indication of a second DRX configuration; determining whether the second DRX configuration is accepted for the at least one sidelink communication; and transmitting, to the second UE, an indication of whether the second DRX configuration is accepted for the at least one sidelink communication.

Aspect 28. The method of one of aspects 18-27, further comprising receiving the indication of a second sidelink DRX configuration in at least one sidelink control information (SCI) or a medium access control (MAC) control element (CE).

Aspect 29. The method of aspect 28, wherein the indication of the second sidelink DRX configuration comprises a wake up indication indicating to the first UE to wake for reception of data.

Aspect 30. The method of one of aspects 28-29, wherein the indication of the second sidelink DRX configuration comprises an indication of a resource pool associated with the second sidelink DRX configuration.

Aspect 31. A method for wireless communication by a base station, comprising: receiving, from a user equipment (UE), information regarding communicating using sidelink discontinuous reception (DRX) or one or more preferred sidelink DRX configurations for at least one application or service with at least one sidelink communication; determining at least one first sidelink DRX configuration to be used for the at least one sidelink communication; transmitting, to the UE, an indication of the at least one first DRX configuration; and receiving, from the UE, an indication of whether the at least one first DRX configuration is accepted for the at least one sidelink communication.

Aspect 32. The method of aspect 31, wherein the indication of whether the at least one first DRX configuration is accepted for the at least one sidelink communication comprises an indication that the at least one first sidelink DRX configuration is rejected, the method further comprising: determining a second sidelink DRX configuration to be used for the at least one sidelink communication; and transmitting the second sidelink DRX configuration to the UE.

Aspect 33. The method of one of aspects 31-32, further comprising: determining a second sidelink DRX configuration to be used for the at least one sidelink communication; transmitting, to the UE, an indication of the second sidelink DRX configuration to be used; and receiving, from the UE, an indication of whether the second sidelink DRX configuration is accepted for the at least one sidelink communication.

Aspect 34. The method of one of aspects 31-33, wherein the information comprises an indication of whether the at least one sidelink communication is unicast, groupcast, or broadcast.

Aspect 35. The method of one of aspects 1-34, wherein determining the information or the one or more sidelink DRX configurations for the at least one application or service comprises receiving, from a higher layer of the UE, the information or the one or more sidelink DRX configurations for the at least one application or service.

Aspect 36. A method for wireless communication by a first user equipment (UE), comprising: receiving information regarding at least one sidelink communication using sidelink discontinuous reception (DRX) for at least one application or service; determining at least one first sidelink DRX configuration based on the information; transmitting, to at least one second UE, an indication of the at least one first sidelink DRX configuration for the at least one sidelink communication; and receiving, from the at least one second UE, an indication of whether the at least one first sidelink DRX configuration is accepted for the at least one sidelink communication.

Aspect 37. The method of aspect 36, wherein the information includes sidelink DRX configurations.

Aspect 38. The method of one of aspects 36-37, wherein the information is received from a higher layer or the second UE.

Aspect 39. The method of one of aspects 36-37, wherein the information comprises an indication of whether the at least one sidelink communication is unicast, groupcast, or broadcast.

Aspect 40. The method of one of aspects 36-37, further comprising establishing a sidelink radio resource control (RRC) connection with the at least one second UE, wherein the indication of the at least one first DRX configuration to the at least one second UE is transmitted via the sidelink RRC connection.

Aspect 41. The method of one of aspects 36-37, wherein receiving the indication of whether the at least one first DRX configuration is accepted comprises receiving, from the at least one second UE, a message rejecting the at least one first DRX configuration, the method further comprising: determining a second DRX configuration in response to the message rejecting the first DRX configuration; and transmitting an indication of the second DRX configuration.

Aspect 42. The method of aspect 41, wherein the message rejecting the at least one first DRX configuration comprises an indication of a preferred DRX configuration to be used, the determination of the second DRX configuration being based on the indication of the preferred DRX configuration.

Aspect 43. The method of one of aspects 41-42, further comprising receiving another message having an indication of a preferred DRX configuration to be used, the determination of the second DRX configuration being based on the indication of the preferred DRX configuration.

Aspect 44. The method of one of aspects 36-43, wherein the at least one sidelink communication using sidelink DRX comprises a communication among UEs using a service via broadcast, a communication among UEs of a group via groupcast, or a communication between a UE pair via unicast.

Aspect 45. The method of one of aspects 36-44, further comprises communicating with the at least one second UE using the at least one first DRX configuration if the at least one first DRX configuration is accepted.

Aspect 46. The method of aspect 45, further comprising: receiving, from a higher layer of the first UE or from one of the at least one second UE, an indication that a current DRX configuration is to be reconfigured; determining a second DRX configuration based on the indication from the higher layer or from the at least one second UE; transmitting, to at least one second UE, an indication of the second DRX configuration; and receiving, from the at least one second UE, an indication of whether the second DRX configuration is accepted for the at least one sidelink communication.

Aspect 47. The method of one of aspects 36-46, further comprising: transmitting, to a base station, an indication of the information regarding communicating using the sidelink DRX; and receiving, from the base station, an indication of the at least one first DRX configuration to be transmitted to the at least one second UE.

Aspect 48. The method of aspect 47, further comprising: receiving, from the base station, an indication of a second DRX configuration to be used; transmitting, to the at least one second UE, an indication of the second DRX configuration; and receiving, from the at least one second UE, an indication of whether the second DRX configuration is accepted for the at least one sidelink communication.

Aspect 49. The method of one of aspects 36-48, further comprising: determining a second sidelink DRX configuration to be selected or switched to; and transmitting an indication of the second sidelink DRX configuration in at least one sidelink control information (SCI) or a medium access control (MAC) control element (CE).

Aspect 50. The method of aspect 49, wherein the indication of the second sidelink DRX configuration comprises a wake up indication indicating to the at least one second UE to wake for reception of data.

Aspect 51. A method for wireless communication by a first user equipment (UE), comprising: receiving, from a second UE, an indication of at least one first sidelink discontinuous reception (DRX) configuration for at least one application or service to be used for at least one sidelink communication using sidelink DRX; determining whether the at least one first sidelink DRX configuration is acceptable for the at least one sidelink communication using the sidelink DRX; and transmitting, to the second UE, an indication of whether the at least one first sidelink DRX configuration is accepted for the at least one sidelink communication based on the determination.

Aspect 52. The method of aspect 51, wherein transmitting the indication of whether the at least one first DRX configuration is accepted comprises transmitting, to the second UE, a message rejecting the at least one first DRX configuration, the method further comprising receiving an indication of a second DRX configuration in response to the message rejecting the first DRX configuration.

Aspect 53. The method of aspect 52, wherein the message rejecting the at least one first DRX configuration comprises an indication of a preferred DRX configuration to be used in response to the rejection of the first DRX configuration.

Aspect 54. The method of one of aspects 51-53, wherein the at least one sidelink communication using the sidelink DRX comprises a communication among UEs using a service via broadcast, a communication among UEs of a group via groupcast, or a communication between a UE pair via unicast.

Aspect 55. The method of one of aspects 51-54, further comprises communicating with the second UE using the at least one first DRX configuration if the at least one first DRX configuration is accepted.

Aspect 56. The method of aspect 55, further comprising: receiving, from the second UE, an indication of a second DRX configuration; determining whether the second DRX configuration is accepted for the at least one sidelink communication; and transmitting, to the second UE, an indication of whether the second DRX configuration is accepted for the at least one sidelink communication.

Aspect 57. The method of one of aspects 51-56, further comprising receiving the indication of a second sidelink DRX configuration in at least one sidelink control information (SCI) or a medium access control (MAC) control element (CE).

Aspect 58. The method of aspect 57, wherein the indication of the second sidelink DRX configuration comprises a wake up indication indicating to the first UE to wake for reception of data.

Aspect 59. A method for wireless communication by a base station, comprising: receiving, from a user equipment (UE), information regarding at least one sidelink communication using sidelink discontinuous reception (DRX) for at least one application or service; determining at least one first sidelink DRX configuration to be used for the at least one sidelink communication based on the information; transmitting, to the UE, an indication of the at least one first DRX configuration; and receiving, from the UE, an indication of whether the at least one first DRX configuration is accepted for the at least one sidelink communication.

Aspect 60. The method of aspect 59, wherein the information comprises one or more preferred sidelink DRX configurations.

Aspect 61. The method of one of aspects 59-60, wherein the indication of whether the at least one first DRX configuration is accepted for the at least one sidelink communication comprises an indication that the at least one first sidelink DRX configuration is rejected, the method further comprising: determining a second sidelink DRX configuration to be used for the at least one sidelink communication; and transmitting the second sidelink DRX configuration to the UE.

Aspect 62. The method of one of aspects 59-61, further comprising: determining a second sidelink DRX configuration to be used for the at least one sidelink communication; transmitting, to the UE, an indication of the second sidelink DRX configuration to be used; and receiving, from the UE, an indication of whether the second sidelink DRX configuration is accepted for the at least one sidelink communication.

Aspect 63. The method of one of aspects 59-62, wherein the information comprises an indication of whether the at least one sidelink communication is unicast, groupcast, or broadcast.

Aspect 64: An apparatus, comprising: a memory comprising executable instructions; one or more processors configured to execute the executable instructions and cause the apparatus to perform a method in accordance with any one of Aspects 1-63.

Aspect 65: An apparatus, comprising means for performing a method in accordance with any one of Aspects 1-63.

Aspect 66: A non-transitory computer-readable medium comprising executable instructions that, when executed by one or more processors of an apparatus, cause the apparatus to perform a method in accordance with any one of Aspects 1-63.

Aspect 67: A computer program product embodied on a computer-readable storage medium comprising code for performing a method in accordance with any one of Aspects 1-63.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, important mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of a list of” items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication by a first user equipment (UE), comprising:
a memory; and
one or more processors coupled to the memory, the memory and the one or more processors being configured to:
receive information regarding at least one sidelink communication using sidelink discontinuous reception (DRX) for at least one application or service;
determine at least one first sidelink DRX configuration based on the information;
transmit, to at least one second UE, an indication of the at least one first sidelink DRX configuration for the at least one sidelink communication; and
receive, from the at least one second UE, an indication of whether the at least one first sidelink DRX configuration is accepted for the at least one sidelink communication.

2. The apparatus of claim 1, wherein the information includes sidelink DRX configurations.

3. The apparatus of claim 1, wherein the information is received from a higher layer or the second UE.

4. The apparatus of claim 1, wherein the information comprises an indication of whether the at least one sidelink communication is unicast, groupcast, or broadcast.

5. The apparatus of claim 1, wherein the memory and the one or more processors are further configured to establish a sidelink radio resource control (RRC) connection with the at least one second UE, wherein the indication of the at least one first DRX configuration to the at least one second UE is transmitted via the sidelink RRC connection.

6. The apparatus of claim 1, wherein receiving the indication of whether the at least one first DRX configuration is accepted comprises receiving, from the at least one second UE, a message rejecting the at least one first DRX configuration, wherein the memory and the one or more processors are further configured to:
determine a second DRX configuration in response to the message rejecting the first DRX configuration; and
transmit an indication of the second DRX configuration.

7. The apparatus of claim 6, wherein the message rejecting the at least one first DRX configuration comprises an indication of a preferred DRX configuration to be used, the determination of the second DRX configuration being based on the indication of the preferred DRX configuration.

8. The apparatus of claim 6, wherein the memory and the one or more processors are further configured to receive another message having an indication of a preferred DRX configuration to be used, the determination of the second DRX configuration being based on the indication of the preferred DRX configuration.

9. The apparatus of claim 1, wherein the at least one sidelink communication using sidelink DRX comprises a communication among UEs using a service via broadcast, a communication among UEs of a group via groupcast, or a communication between a UE pair via unicast.

10. The apparatus of claim 1, wherein the memory and the one or more processors are further configured to communicate with the at least one second UE using the at least one first DRX configuration if the at least one first DRX configuration is accepted.

11. The apparatus of claim 10, wherein the memory and the one or more processors are further configured to:
receive, from a higher layer of the first UE or from one of the at least one second UE, an indication that a current DRX configuration is to be reconfigured;
determine a second DRX configuration based on the indication from the higher layer or from the at least one second UE;
transmit, to at least one second UE, an indication of the second DRX configuration; and
receive, from the at least one second UE, an indication of whether the second DRX configuration is accepted for the at least one sidelink communication.

12. The apparatus of claim 1, wherein the memory and the one or more processors are further configured to:
transmit, to a base station, an indication of the information regarding communicating using the sidelink DRX; and
receive, from the base station, an indication of the at least one first DRX configuration to be transmitted to the at least one second UE.

13. The apparatus of claim 12, wherein the memory and the one or more processors are further configured to:
receive, from the base station, an indication of a second DRX configuration to be used;
transmit, to the at least one second UE, an indication of the second DRX configuration; and
receive, from the at least one second UE, an indication of whether the second DRX configuration is accepted for the at least one sidelink communication.

14. The apparatus of claim 1, wherein the memory and the one or more processors are further configured to:
determine a second sidelink DRX configuration to be selected or switched to; and
transmit an indication of the second sidelink DRX configuration in at least one sidelink control information (SCI) or a medium access control (MAC) control element (CE).

15. The apparatus of claim 14, wherein the indication of the second sidelink DRX configuration comprises a wake up indication indicating to the at least one second UE to wake for reception of data.

16. An apparatus for wireless communication by a first user equipment (UE), comprising:
a memory; and
one or more processors coupled to the memory, the memory and the one or more processors being configured to:
receive, from a second UE, an indication of at least one first sidelink discontinuous reception (DRX) configuration for at least one application or service to be used for at least one sidelink communication using sidelink DRX;
determine whether the at least one first sidelink DRX configuration is acceptable for the at least one sidelink communication using the sidelink DRX; and
transmit, to the second UE, an indication of whether the at least one first sidelink DRX configuration is accepted for the at least one sidelink communication based on the determination.

17. The apparatus of claim 16, wherein transmitting the indication of whether the at least one first DRX configuration is accepted comprises transmitting, to the second UE, a message rejecting the at least one first DRX configuration, wherein the memory and the one or more processors are further configured to receive an indication of a second DRX configuration in response to the message rejecting the first DRX configuration.

18. The apparatus of claim 17, wherein the message rejecting the at least one first DRX configuration comprises an indication of a preferred DRX configuration to be used in response to the rejection of the first DRX configuration.

19. The apparatus of claim 16, wherein the at least one sidelink communication using the sidelink DRX comprises a communication among UEs using a service via broadcast, a communication among UEs of a group via groupcast, or a communication between a UE pair via unicast.

20. The apparatus of claim 16, wherein the memory and the one or more processors are further configured to communicate with the second UE using the at least one first DRX configuration if the at least one first DRX configuration is accepted.

21. The apparatus of claim 20, wherein the memory and the one or more processors are further configured to:
receive, from the second UE, an indication of a second DRX configuration;
determine whether the second DRX configuration is accepted for the at least one sidelink communication; and
transmit, to the second UE, an indication of whether the second DRX configuration is accepted for the at least one sidelink communication.

22. The apparatus of claim 16, wherein the memory and the one or more processors are further configured to receive the indication of a second sidelink DRX configuration in at least one sidelink control information (SCI) or a medium access control (MAC) control element (CE).

23. The apparatus of claim 22, wherein the indication of the second sidelink DRX configuration comprises a wake up indication indicating to the first UE to wake for reception of data.

24. An apparatus for wireless communication by a base station, comprising:
a memory; and
one or more processors coupled to the memory, the memory and the one or more processors being configured to:
receive, from a user equipment (UE), information regarding at least one sidelink communication using sidelink discontinuous reception (DRX) for at least one application or service;
determine at least one first sidelink DRX configuration to be used for the at least one sidelink communication based on the information;
transmit, to the UE, an indication of the at least one first DRX configuration; and
receive, from the UE, an indication of whether the at least one first DRX configuration is accepted for the at least one sidelink communication.

25. The apparatus of claim 24, wherein the information comprises one or more preferred sidelink DRX configurations.

26. The apparatus of claim 24, wherein the indication of whether the at least one first DRX configuration is accepted for the at least one sidelink communication comprises an indication that the at least one first sidelink DRX configuration is rejected, wherein the memory and the one or more processors are further configured to:
determine a second sidelink DRX configuration to be used for the at least one sidelink communication; and
transmit the second sidelink DRX configuration to the UE.

27. The apparatus of claim 24, wherein the memory and the one or more processors are further configured to:
determine a second sidelink DRX configuration to be used for the at least one sidelink communication;
transmit, to the UE, an indication of the second sidelink DRX configuration to be used; and
receive, from the UE, an indication of whether the second sidelink DRX configuration is accepted for the at least one sidelink communication.

28. The apparatus of claim 24, wherein the information comprises an indication of whether the at least one sidelink communication is unicast, groupcast, or broadcast.

29. A method for wireless communication by a first user equipment (UE), comprising:
receiving information regarding communicating using sidelink discontinuous reception (DRX) for at least one application or service for at least one sidelink communication;
determining at least one first sidelink DRX configuration based on the information;
transmitting, to at least one second UE, an indication of the at least one first sidelink DRX configuration for the at least one sidelink communication; and
receiving, from the at least one second UE, an indication of whether the at least one first sidelink DRX configuration is accepted for the at least one sidelink communication.

30. The method of claim 29, further comprising communicating with the at least one second UE using the at least one first DRX configuration if the at least one first DRX configuration is accepted.
